(19) United States
(12) Patent Application Publication
(10) Pub. No.: US 2026/0368878 A1
(43) Pub. Date: Nov. 19, 2026

(54) GEOMETRIC QUALITY CONTROL OF WORKPIECES

(71) Applicant: SiLC Technologies, Inc., Monrovia, CA (US)

(72) Inventors: Nirmal Warke, Saratoga, CA (US); Mehdi Asghari, La Canada Flintridge, CA (US)

(21) Appl. No.: 19/277,322

(22) Filed: Jul. 22, 2025

Related U.S. Application Data
(60) Provisional application No. 63/805,149, filed on May 13, 2025.

(51) Int. Cl. G06T 7/00; G01S 7/48; G01S 17/86; G06T 7/73

(52) U.S. Cl. CPC G06T 7/0004; G01S 7/4802; G01S 17/86; G06T 7/75; G06T 2207/30164; G06T 2207/30244

(57) ABSTRACT

A quality control system has a camera configured to generate data for a two-dimensional image of a three-dimensional workpiece positioned in an evaluation space. The system also includes an electronic model file that indicates a position of a model within a model space. The model is a model representation of the workpiece. The model file containing a location of a region of interest within the model space. The region of interest is a region of the model. The electronics are configured to transform the location of the region of interest within the model space to a location of the region of interest within the evaluation space. The system also includes a LIDAR system configured to scan a system output signal within the evaluation space such that the system output signal is scanned to multiple sample regions within the location of the region of interest in the evaluation space.

### RELATED APPLICATIONS

This application claims the benefit of U.S. Provisional Patent Application Ser. No. 63/805,149, filed on May 13, 2025, entitled “Geometric Quality Control of Workpieces,” and incorporated herein in it.

### FIELD

The invention relates to optical systems. In particular, the invention relates to quality control systems.

### BACKGROUND

The geometric characteristics of parts can be an important criterion when manufacturing parts that are to be incorporated into larger products. Errors in geometric characteristics such as shape and dimension of one part can interference for the entire manufacturing process.

Current methods of controlling for quality of the geometric characteristics of parts include the use of optical comparators, measuring hand tools, and coordinate measuring machines (CMMs). The use of optical comparators and measuring hand tools requires extreme expertise and is prone to errors. CMM machines can be accurate but have low speeds, require physical touch of a probe tip to the part, and are often limited to parts that are smaller in size and weigh less. As a result, there is a need for an improved system of measuring the geometric characteristics of parts.

### SUMMARY

A quality control system has a camera configured to generate data for a two-dimensional image of a three-dimensional workpiece positioned in an evaluation space. The system also includes an electronic model file that indicates the position of a model within a model space. The model is a model representation of the workpiece. The model file contains a location of a region of interest within the model space. The region of interest is a region of the model. The electronics are configured to transform the location of the region of interest within the model space to a location of the region of interest within the evaluation space. The system also includes a LIDAR system configured to scan a system output signal within the evaluation space such that the system output signal is scanned to multiple sample regions within the location of the region of interest in the evaluation space.

A method of quality control includes generating data for a two-dimensional image of a three-dimensional workpiece positioned in an evaluation space. The method includes storing a model file that indicates the position of a model within a model space. The model is a model of the workpiece. The model file contains a location of a region of interest within the model space. The region of interest is a region of the model. The electronics are configured to transform the location of the region of interest within the model space to a location of the region of interest within the evaluation space. The method also includes operating a LIDAR system so as to scan a system output signal within the evaluation space such that the system output signal is scanned to multiple sample regions within the location of the region of interest in the evaluation space.

### BRIEF DESCRIPTION OF THE FIGURES

FIG. 1A is a topview of a schematic of a LIDAR system that includes or consists of a LIDAR chip that outputs a LIDAR output signal and receives a LIDAR input signal on a common waveguide.

FIG. 1B is a topview of a schematic of a LIDAR system that includes or consists of a LIDAR chip that outputs a LIDAR output signal and receives a LIDAR input signal on different waveguides.

FIG. 1C is a topview of a schematic of another embodiment of a LIDAR system that includes or consists of a LIDAR chip that outputs a LIDAR output signal and receives multiple LIDAR input signals on different waveguides.

FIG. 2 is a topview of an example of a LIDAR adapter that is suitable for use with the LIDAR chip of FIG. 1B.

FIG. 3 is a topview of an example of a LIDAR adapter that is suitable for use with the LIDAR chip of FIG. 1C.

FIG. 4A is a topview of an example of a LIDAR system that includes the LIDAR chip of FIG. 1B and the LIDAR adapter of FIG. 2 on a common support.

FIG. 4B is a topview of an example of a LIDAR system that includes the LIDAR chip of FIG. 1A.

FIG. 5A illustrates an example of a processing component suitable for use with the LIDAR systems.

FIG. 5B provides a schematic of electronics that are suitable for use with a processing component constructed according to FIG. 5A.

FIG. 5C is a graph of a frequency versus time pattern for a system output signal with triangular frequency tuning.

FIG. 5D illustrates another example of a processing component suitable for use with the LIDAR systems.

FIG. 5E provides a schematic of electronics that are suitable for use with a processing component constructed according to FIG. 5D.

FIG. 6 is a schematic of an example of a beam scanner suitable for use with the LIDAR system.

FIG. 7 illustrates a relationship between a LIDAR system and a sample region within the field of view of the LIDAR system.

FIG. 8 is a schematic of a quality control system.

FIG. 9 is a topview of a model of a workpiece.

FIG. 10A is a topview of a workpiece positioned in an evaluation space of a quality control system.

FIG. 10B is an image of the workpiece shown in FIG. 10A.

FIG. 11 illustrates the preliminary camera and the LIDAR system of a quality control system positioned in the model space at a particular pose relative to a model in the model space.

FIG. 12 illustrates the quality control system of FIG. 8 with the workpiece of FIG. 10A positioned in an evaluation space of the quality control system.

FIG. 13 is a process flow for the operation of the quality control system.

### DESCRIPTION

A quality control system has a camera configured to generate data for a two-dimensional image of a three-dimensional workpiece positioned in an evaluation space. An RGB digital camera can serve as an example of the camera. The system has electronics that store a three-dimensional model file of the workpiece design. The model file uses a model space coordinate system to describe the position and geometry of the model within the model space. The model file also uses the model space coordinate system to define one or more regions of interest within the model space. Each region of interest is a region of the model where it is desirable to have accurate information regarding the geometric characteristics of the model. The electronics are configured to transform the location of the region of interest within the model space to the location of the region of interest within the evaluation space.

The system also includes a LIDAR system configured to scan a system output signal within the evaluation space. The LIDAR system can scan the system output signal so as to target the one or more regions of interest in the evaluation space. The transform between the model space and the evaluation space is selected such that the location of the region of interest within the evaluation space relative to the workpiece approximates, or corresponds to, the location of the region of interest relative to the model in the model space. As a result, scanning the system output signal within the region of interest in the evaluation space effectively scans the portion of the workpiece that corresponds to the region of interest on the model. As a result, the LIDAR system can generate a three-dimensional image of the region of interest of the workpiece in the evaluation space. The LIDAR system can compare the three-dimensional image of the region of interest on the workpiece to the three-dimensional image of the model so as to evaluate whether the geometry of the region of interest is an acceptable match to the geometry of the corresponding region of interest on the model.

The preliminary camera can be a focal plane array imager capable of high levels of lateral resolution. The high degree of lateral resolution provides the transform with a high degree of accuracy. While LIDAR systems can provide high degrees of resolution in the vertical direction, these systems generally do not provide comparable resolution in the lateral direction by themselves. Using the transform generated from the camera output to identify the locations where the LIDAR system should scan allows the LIDAR system to take advantage of the lateral resolution provided by the camera.

The transformation between the model space and the evaluation space can be generated from a comparison of the model file with the data for the two-dimensional image. As a result, the transform can be a function of the orientation and location of the workpiece relative to the camera. Since the transform can be specific to the orientation and location of the workpiece, the placement of the workpiece relative to the camera can vary. For instance, different workpieces can have different orientations and locations relative to the camera. As a result, precise alignment between the workpiece and one or more elements of the quality control system is not required.

Additionally, since the quality control system uses a camera and LIDAR system to evaluate the geometric properties of the workpiece, physical contact between the workpiece and a measuring instrument is not necessary. Further, since the LIDAR system can scan a region of the workpiece rather than the entire workpiece, the quality control system can rapidly evaluate the geometric characteristics of workpieces including large and/or heavy workpieces. Additionally, or alternately, the reduced time needed to scan a region of the workpiece allows the resolution of the scan to be increased. Accordingly, the region of interest can be scanned at increased resolution levels.

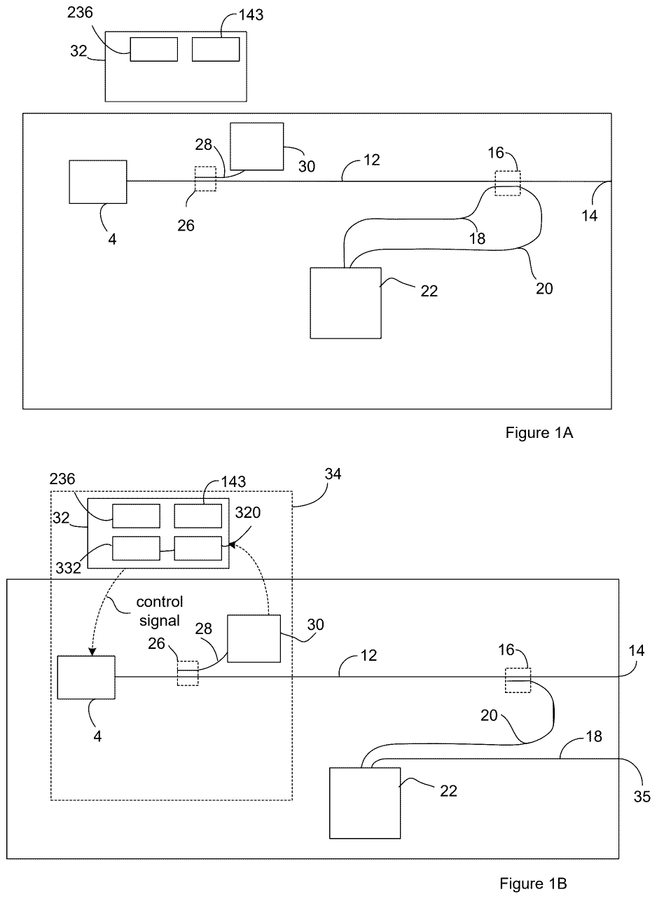

FIG. 1A is a topview of a schematic of a LIDAR chip that can serve as a LIDAR system or can be included in a LIDAR system that includes components in addition to the LIDAR chip. The LIDAR chip can include a Photonic Integrated Circuit (PIC) and can be a Photonic Integrated Circuit chip. The LIDAR chip includes a light source 4 that outputs a preliminary outgoing LIDAR signal. A suitable light source 4 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

The LIDAR chip includes a utility waveguide 12 that receives an outgoing LIDAR signal from a light source 4. The utility waveguide 12 terminates at a facet 14 and carries the outgoing LIDAR signal to the facet 14. The facet 14 can be positioned such that the outgoing LIDAR signal traveling through the facet 14 exits the LIDAR chip and serves as a LIDAR output signal. For instance, the facet 14 can be positioned at an edge of the chip so the outgoing LIDAR signal traveling through the facet 14 exits the chip and serves as the LIDAR output signal. In some instances, the portion of the LIDAR output signal that has exited from the LIDAR chip can also be considered a system output signal. As an example, when the exit of the LIDAR output signal from the LIDAR chip is also an exit of the LIDAR output signal from the LIDAR system, the LIDAR output signal can also be considered a system output signal.

The LIDAR output signal travels away from the LIDAR system through free space in the atmosphere in which the LIDAR system is positioned. The LIDAR output signal may be reflected by one or more objects in the path of the LIDAR output signal. When the LIDAR output signal is reflected, at least a portion of the reflected light travels back toward the LIDAR chip as a LIDAR input signal. In some instances, the LIDAR input signal can also be considered a system return signal. As an example, when the exit of the LIDAR output signal from the LIDAR chip is also an exit of the LIDAR output signal from the LIDAR system, the LIDAR input signal can also be considered a system return signal.

The LIDAR input signals can enter the utility waveguide 12 through the facet 14. The portion of the LIDAR input signal that enters the utility waveguide 12 serves as an incoming LIDAR signal. The utility waveguide 12 carries the incoming LIDAR signal to a splitter 16 that moves a portion of the outgoing LIDAR signal from the utility waveguide 12 onto a comparative waveguide 18 as a comparative signal. The comparative waveguide 18 carries the comparative signal to a processing component 22 for further processing. Although FIG. 1A illustrates a directional coupler operating as the splitter 16, other signal tapping components can be used as the splitter 16. Suitable splitters 16 include, but are not limited to, directional couplers, optical couplers, y-junctions, tapered couplers, and Multi-Mode Interference (MMI) devices.

The utility waveguide 12 also carries the outgoing LIDAR signal to the splitter 16. The splitter 16 moves a portion of the outgoing LIDAR signal from the utility waveguide 12 onto a reference waveguide 20 as a reference signal. The reference waveguide 20 carries the reference signal to the processing component 22 for further processing.

The percentage of light transferred from the utility waveguide 12 by the splitter 16 can be fixed or substantially fixed. For instance, the splitter 16 can be configured such that the power of the reference signal transferred to the reference waveguide 20 is an outgoing percentage of the power of the outgoing LIDAR signal or such that the power of the comparative signal transferred to the comparative waveguide 18 is an incoming percentage of the power of the incoming LIDAR signal. In many splitters 16, such as directional couplers and multimode interferometers (MMIs), the outgoing percentage is equal or substantially equal to the incoming percentage. In some instances, the outgoing percentage is greater than 30%, 40%, or 49% and/or less than 51%, 60%, or 70% and/or the incoming percentage is greater than 30%, 40%, or 49% and/or less than 51%, 60%, or 70%. A splitter 16, such as a multimode interferometer (MMI), generally provides an outgoing percentage and an incoming percentage of 50% or about 50%. However, multimode interferometers (MMIs) can be easier to fabricate in platforms such as silicon-on-insulator platforms than some alternatives. In one example, the splitter 16 is a multimode interferometer (MMI) and the outgoing percentage and the incoming percentage are 50% or substantially 50%. As will be described in more detail below, the processing component 22 combines the comparative signal with the reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The LIDAR chip can include a control branch for controlling operation of the light source 4. The control branch includes a splitter 26 that moves a portion of the outgoing LIDAR signal from the utility waveguide 12 onto a control waveguide 28. The coupled portion of the outgoing LIDAR signal serves as a tapped signal. Although FIG. 1A illustrates a directional coupler operating as the splitter 26, other signal tapping components can be used as the splitter 26. Suitable splitters 26 include, but are not limited to, directional couplers, optical couplers, y-junctions, tapered couplers, and Multi-Mode Interference (MMI) devices.

The control waveguide 28 carries the tapped signal to control components 30. The control components 30 can be in electrical communication with electronics 32. All or a portion of the control components 30 can be included in the electronics 32. During operation, the electronics can employ output from the control components 30 in a feedback loop (not shown) configured to control a frequency versus time pattern of a controlled light signal such as the tapped signal.

The LIDAR system can be modified so the incoming LIDAR signal and the outgoing LIDAR signal can be carried on different waveguides. For instance, FIG. 1B is a topview of the LIDAR chip of FIG. 1A modified such that the incoming LIDAR signal and the outgoing LIDAR signal are carried on different waveguides. The outgoing LIDAR signal exits the LIDAR chip through the facet 14 and serves as the LIDAR output signal. When light from the LIDAR output signal is reflected by an object external to the LIDAR system, at least a portion of the reflected light returns to the LIDAR chip as a first LIDAR input signal. The first LIDAR input signal enters the comparative waveguide 18 through a facet 35 and serves as the comparative signal. The comparative waveguide 18 carries the comparative signal to a processing component 22 for further processing. As described in the context of FIG. 1A, the reference waveguide 20 carries the reference signal to the processing component 22 for further processing. As will be described in more detail below, the processing component 22 combines the comparative signal with the reference signal to form a composite signal that carries LIDAR data for a sample region on the field of view.

The LIDAR chips can be modified to receive multiple LIDAR input signals. For instance, FIG. 1C illustrates the LIDAR chip of FIG. 1B modified to receive two LIDAR input signals. A splitter 40 is configured to place a portion of the reference signal carried on the reference waveguide 20 on a first reference waveguide 42 and another portion of the reference signal on a second reference waveguide 44. Accordingly, the first reference waveguide 42 carries a first reference signal and the second reference waveguide 44 carries a second reference signal. The first reference waveguide 42 carries the first reference signal to a first processing component 46 and the second reference waveguide 44 carries the second reference signal to a second processing component 48. Examples of suitable splitters 40 include, but are not limited to, y-junctions, optical couplers, and multi-mode interference couplers (MMIs).

The outgoing LIDAR signal exits the LIDAR chip through the facet 14 and serves as the LIDAR output signal. When light from the LIDAR output signal is reflected by one or more objects located external to the LIDAR system, at least a portion of the reflected light returns to the LIDAR chip as a first LIDAR input signal. The first LIDAR input signal enters the comparative waveguide 18 through the facet 35 and serves as a first comparative signal. The comparative waveguide 18 carries the first comparative signal to a first processing component 46 for further processing.

Additionally, when light from the LIDAR output signal is reflected by one or more objects located external to the LIDAR system, at least a portion of the reflected signal returns to the LIDAR chip as a second LIDAR input signal. The second LIDAR input signals enter a second comparative waveguide 50 through a facet 52 and serves as a second comparative signal carried by the second comparative waveguide 50. The second comparative waveguide 50 carries the second comparative signal to a second processing component 48 for further processing.

Although the light source 4 is shown as being positioned on the LIDAR chip, the light source 4 can be located off the LIDAR chip. For instance, the utility waveguide 12 can terminate at a second facet through which the outgoing LIDAR signal can enter the utility waveguide 12 from a light source 4 located off the LIDAR chip.

In some instances, a LIDAR chip constructed according to FIG. 1B or FIG. 1C is used in conjunction with a LIDAR adapter. In some instances, the LIDAR adapter can be physically optically positioned between the LIDAR chip and the one or more reflecting objects and/or the field of view in that an optical path that the first LIDAR input signal(s) and/or the LIDAR output signal travels from the LIDAR chip to the field of view passes through the LIDAR adapter. Additionally, the LIDAR adapter can be configured to operate on the first LIDAR input signal and the LIDAR output signal such that the first LIDAR input signal and the LIDAR output signal travel on different optical pathways between the LIDAR adapter and the LIDAR chip but on the same optical pathway between the LIDAR adapter and a reflecting object in the field of view.

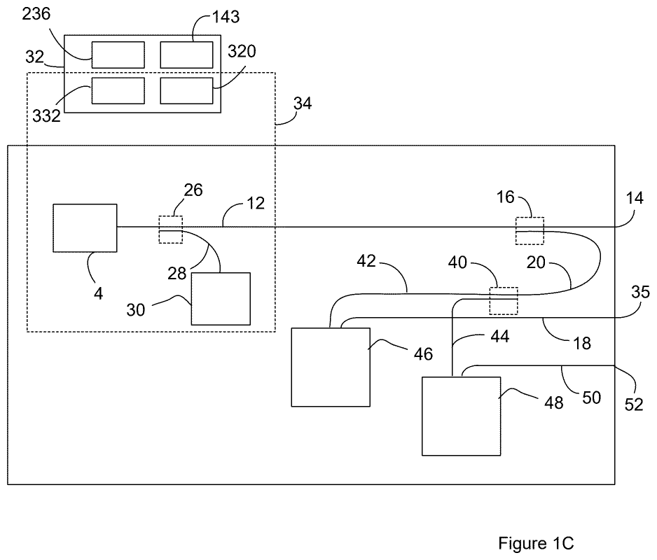

An example of a LIDAR adapter that is suitable for use with the LIDAR chip of FIG. 1B is illustrated in FIG. 2. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108. The LIDAR output signal enters the first port 104 from the utility waveguide 12 of the LIDAR chip and exits from the second port 106.

The LIDAR adapter can be configured such that the output of the LIDAR output signal from the second port 106 can also serve as the output of the LIDAR output signal from the LIDAR adapter and accordingly from the LIDAR system. As a result, the LIDAR output signal can be output from the LIDAR adapter such that the LIDAR output signal is traveling toward a sample region in the field of view. Accordingly, in some instances, the portion of the LIDAR output signal that has exited from the LIDAR adapter can also be considered the system output signal. As an example, when the exit of the LIDAR output signal from the LIDAR adapter is also an exit of the LIDAR output signal from the LIDAR system, the LIDAR output signal can also be considered a system output signal.

The LIDAR output signal output from the LIDAR adapter includes, consists of, or consists essentially of light from the LIDAR output signal received from the LIDAR chip. Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

When one or more objects in the sample region reflect the LIDAR output signal, at least a portion of the reflected light travels back to the circulator 100 as a system return signal. The system return signal enters the circulator 100 through the second port 106. FIG. 2 illustrates the LIDAR output signal and the system return signal traveling between the LIDAR adapter and the sample region along the same optical path.

The system return signal exits the circulator 100 through the third port 108 and is directed to the comparative waveguide 18 on the LIDAR chip. Accordingly, all or a portion of the system return signal can serve as the first LIDAR input signal and the first LIDAR input signal includes or consists of light from the system return signal. Accordingly, the LIDAR output signal and the first LIDAR input signal travel between the LIDAR adapter and the LIDAR chip along different optical paths.

As is evident from FIG. 2, the LIDAR adapter can include optical components in addition to the circulator 100. For instance, the LIDAR adapter can include components for directing and controlling the optical path of the LIDAR output signal and the system return signal. As an example, the adapter of FIG. 2 includes an optional amplifier 110 positioned so as to receive and amplify the LIDAR output signal before the LIDAR output signal enters the circulator 100. The amplifier 110 can be operated by the electronics 32 allowing the electronics 32 to control the power of the LIDAR output signal.

FIG. 2 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the LIDAR output signal at a desired location. In some instances, the second lens 114 is configured to focus or collimate the LIDAR output signal at a desired location. For instance, the second lens 114 can be configured to couple the LIDAR output signal to the facet 35 of the comparative waveguide 18.

The LIDAR adapter can also include one or more direction changing components such as mirrors. FIG. 2 illustrates the LIDAR adapter including a mirror as a direction-changing component 116 that redirects the system return signal from the circulator 100 to the facet 20 of the comparative waveguide 18.

The LIDAR chips include one or more waveguides that constrains the optical path of one or more light signals. While the LIDAR adapter can include waveguides, the optical path that the system return signal and the LIDAR output signal travel between components on the LIDAR adapter and/or between the LIDAR chip and a component on the LIDAR adapter can be free space. For instance, the system return signal and/or the LIDAR output signal can travel through the atmosphere in which the LIDAR chip, the LIDAR adapter, and/or the base 102 is positioned when traveling between the different components on the LIDAR adapter and/or between a component on the LIDAR adapter and the LIDAR chip. As a result, optical components such as lenses and direction changing components can be employed to control the characteristics of the optical path traveled by the system return signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers, and the remaining components are discrete components.

The LIDAR system can be configured to compensate for polarization. Light from a laser source is typically linearly polarized and hence the LIDAR output signal is also typically linearly polarized. Reflection from an object may change the angle of polarization of the returned light. Accordingly, the system return signal can include light of different linear polarization states. For instance, a first portion of a system return signal can include light of a first linear polarization state and a second portion of a system return signal can include light of a second linear polarization state. The intensity of the resulting composite signals is proportional to the square of the cosine of the angle between the comparative and reference signal polarization fields. If the angle is 90 degrees, the LIDAR data can be lost in the resulting composite signal. However, the LIDAR system can be modified to compensate for changes in polarization state of the LIDAR output signal.

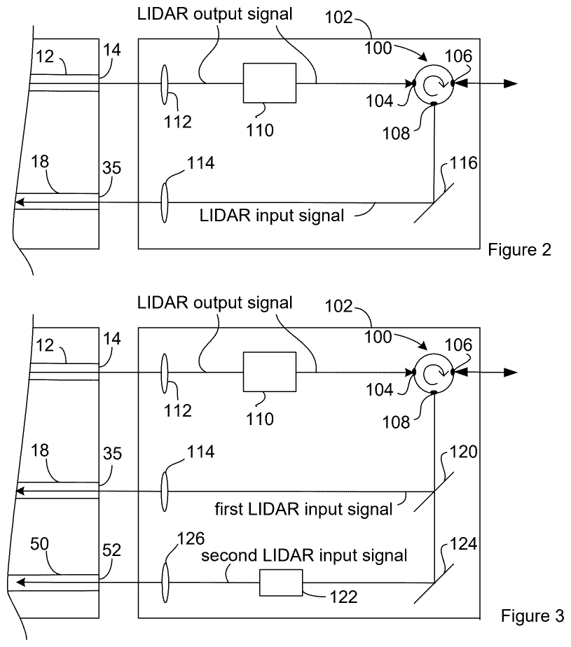

FIG. 3 illustrates the LIDAR system of FIG. 3 modified such that the LIDAR adapter is suitable for use with the LIDAR chip of FIG. 1C. The LIDAR adapter includes a beamsplitter 120 that receives the system return signal from the circulator 100. The beamsplitter 120 splits the system return signal into a first portion of the system return signal and a second portion of the system return signal. Suitable beamsplitters include, but are not limited to, Wollaston prisms, and MEMS-based beamsplitters.

The first portion of the system return signal is directed to the comparative waveguide 18 on the LIDAR chip and serves as the first LIDAR input signal described in the context of FIG. 1C. The second portion of the system return signal is directed to a polarization rotator 122. The polarization rotator 122 outputs a second LIDAR input signal that is directed to the second input waveguide 76 on the LIDAR chip and serves as the second LIDAR input signal.

The beamsplitter 120 can be a polarizing beam splitter. One example of a polarizing beamsplitter is constructed such that the first portion of the system return signal has a first polarization state but does not have or does not substantially have a second polarization state and the second portion of the system return signal has a second polarization state but does not have or does not substantially have the first polarization state. The first polarization state and the second polarization state can be linear polarization states, and the second polarization state is different from the first polarization state. For instance, the first polarization state can be TE and the second polarization state can be TM or the first polarization state can be TM and the second polarization state can be TE. In some instances, the laser source can be linearly polarized such that the LIDAR output signal has the first polarization state. Suitable beamsplitters include, but are not limited to, Wollaston prisms, and MEMs-based polarizing beamsplitters.

A polarization rotator can be configured to change the polarization state of the first portion of the system return signal and/or the second portion of the system return signal. For instance, the polarization rotator 122 shown in FIG. 3 can be configured to change the polarization state of the second portion of the system return signal from the second polarization state to the first polarization state. As a result, the second LIDAR input signal has the first polarization state but does not have or does not substantially have the second polarization state. Accordingly, the first LIDAR input signal and the second LIDAR input signal each have the same polarization state (the first polarization state in this example). Despite carrying light of the same polarization state, the first LIDAR input signal and the second LIDAR input signal are associated with different polarization states as a result of the use of the polarizing beamsplitter. For instance, the first LIDAR input signal carries the light reflected with the first polarization state and the second LIDAR input signal carries the light reflected with the second polarization state. As a result, the first LIDAR input signal is associated with the first polarization state and the second LIDAR input signal is associated with the second polarization state.

Since the first LIDAR input signal and the second LIDAR carry light of the same polarization state, the comparative signals that result from the first LIDAR input signal have the same polarization angle as the comparative signals that result from the second LIDAR input signal.

Suitable polarization rotators include, but are not limited to, rotation of polarization-maintaining fibers, Faraday rotators, half-wave plates, MEMs-based polarization rotators and integrated optical polarization rotators using asymmetric y-branches, Mach-Zehnder interferometers and multi-mode interference couplers.

Since the outgoing LIDAR signal is linearly polarized, the first reference signals can have the same linear polarization state as the second reference signals. Additionally, the components on the LIDAR adapter can be selected such that the first reference signals, the second reference signals, the comparative signals and the second comparative signals each have the same polarization state. In the example disclosed in the context of FIG. 3, the first comparative signals, the second comparative signals, the first reference signals, and the second reference signals can each have light of the first polarization state.

As a result of the above configuration, first composite signals generated by the first processing component 46 and second composite signals generated by the second processing component 48 each results from combining a reference signal and a comparative signal of the same polarization state and will accordingly provide the desired beating between the reference signal and the comparative signal. For instance, the composite signal results from combining a first reference signal and a first comparative signal of the first polarization state and excludes or substantially excludes light of the second polarization state or the composite signal results from combining a first reference signal and a first comparative signal of the second polarization state and excludes or substantially excludes light of the first polarization state. Similarly, the second composite signal includes a second reference signal, and a second comparative signal of the same polarization state will accordingly provide the desired beating between the reference signal and the comparative signal. For instance, the second composite signal results from combining a second reference signal and a second comparative signal of the first polarization state and excludes or substantially excludes light of the second polarization state or the second composite signal results from combining a second reference signal and a second comparative signal of the second polarization state and excludes or substantially excludes light of the first polarization state.

The above configuration results in the LIDAR data for a single sample region in the field of view being generated from multiple different composite signals (i.e. first composite signals and the second composite signal) from the sample region. In some instances, determining the LIDAR data for the sample region includes the electronics combining the LIDAR data from different composite signals (i.e. the composite signals and the second composite signal). Combining the LIDAR data can include taking an average, median, or mode of the LIDAR data generated from the different composite signals. For instance, the electronics can average the distance between the LIDAR system and the reflecting object determined from the composite signal with the distance determined from the second composite signal and/or the electronics can average the radial velocity between the LIDAR system and the reflecting object determined from the composite signal with the radial velocity determined from the second composite signal.

In some instances, determining the LIDAR data for a sample region includes the electronics identifying one or more composite signals (i.e. the composite signal and/or the second composite signal) as the source of the LIDAR data that most represents reality (the representative LIDAR data). The electronics can then use the LIDAR data from the identified composite signal as the representative LIDAR data to be used for additional processing. For instance, the electronics can identify the signal (composite signal or the second composite signal) with the larger amplitude as having the representative LIDAR data and can use the LIDAR data from the identified signal for further processing by the LIDAR system. In some instances, the electronics combine identifying the composite signal with the representative LIDAR data with combining LIDAR data from different LIDAR signals. For instance, the electronics can identify each of the composite signals with an amplitude above an amplitude threshold as having representative LIDAR data and when more than two composite signals are identified as having representative LIDAR data, the electronics can combine the LIDAR data from each of identified composite signals. When one composite signal is identified as having representative LIDAR data, the electronics can use the LIDAR data from that composite signal as the representative LIDAR data. When none of the composite signals is identified as having representative LIDAR data, the electronics can discard the LIDAR data for the sample region associated with those composite signals.

Although FIG. 3 is described in the context of components being arranged such that the first comparative signals, the second comparative signals, the first reference signals, and the second reference signals each have the first polarization state, other configurations of the components in FIG. 3 can be arranged such that the composite signals result from combining a reference signal and a comparative signal of the same linear polarization state and the second composite signal results from combining a reference signal and a comparative signal of the same linear polarization state. For instance, the beamsplitter 120 can be constructed such that the second portion of the system return signal has the first polarization state and the first portion of the system return signal has the second polarization state, the polarization rotator receives the first portion of the system return signal, and the outgoing LIDAR signal can have the second polarization state. In this example, the first LIDAR input signal and the second LIDAR input signal each has the second polarization state.

The above system configurations result in the first portion of the system return signal and the second portion of the system return signal being directed into different composite signals. As a result, since the first portion of the system return signal and the second portion of the system return signal are each associated with a different polarization state, but electronics can process each of the composite signals, the LIDAR system compensates for changes in the polarization state of the LIDAR output signal in response to reflection of the LIDAR output signal.

The LIDAR adapter of FIG. 3 can include additional optical components including passive optical components. For instance, the LIDAR adapter can include an optional third lens 126. The third lens 126 can be configured to couple the second LIDAR output signal at a desired location. In some instances, the third lens 126 focuses or collimates the second LIDAR output signal at a desired location. For instance, the third lens 126 can be configured to focus or collimate the second LIDAR output signal on the facet 52 of the second comparative waveguide 50. The LIDAR adapter also includes one or more direction changing components 124 such as mirrors and prisms. FIG. 3 illustrates the LIDAR adapter including a mirror as a direction changing component 124 that redirects the second portion of the system return signal from the circulator 100 to the facet 52 of the second comparative waveguide 50 and/or to the third lens 126.

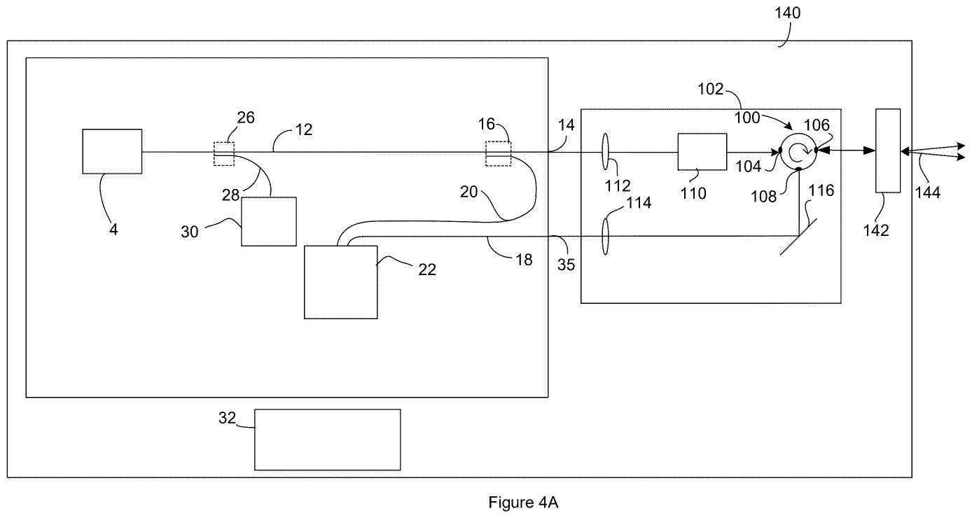

When the LIDAR system includes a LIDAR chip and a LIDAR adapter, the LIDAR chip, electronics, and the LIDAR adapter can be positioned on a common mount. Suitable common mounts include, but are not limited to, glass plates, metal plates, silicon plates and ceramic plates. As an example, FIG. 4A is a topview of a LIDAR system that has a LIDAR assembly that includes the LIDAR chip and electronics 32 of FIG. 1B and the LIDAR adapter of FIG. 2 on a common support 140. FIG. 4B is a topview of a LIDAR system that has a LIDAR assembly that includes the LIDAR chip and electronics 32 of FIG. 1A on a common support 140. Although the electronics 32 are illustrated as being located on the common support, all or a portion of the electronics can be located off the common support. When the light source 4 is located off the LIDAR chip, the light source can be located on the common support 140 or off the common support 140. Suitable approaches for mounting the LIDAR chip, electronics, and/or the LIDAR adapter on the common support include, but are not limited to, epoxy, solder, and mechanical clamping.

The LIDAR systems can include components including additional passive and/or active optical components. For instance, the LIDAR system can include one or more components that receive the LIDAR output signal from the LIDAR chip or from the LIDAR adapter. The portion of the LIDAR output signal that exits from the one or more components can serve as the system output signal. As an example, the LIDAR system can include one or more beam scanners that receive the LIDAR output signal from the assembly. For instance, the LIDAR system can include one or more beam scanners that receive the LIDAR output signal from the LIDAR chip or from the LIDAR adapter and that output all or a fraction of the LIDAR output signal that serves as the system output signal. For instance, FIG. 4A illustrates a beam scanner 142 that receive a LIDAR output signal from the LIDAR adapter. Although FIG. 4A shows the beam scanner positioned on the common support 140, the beam scanner can be positioned on the LIDAR chip, on the LIDAR adapter, off the LIDAR chip, or off the common support 140. Suitable beam scanners include, but are not limited to, movable mirrors, MEMS mirrors, optical phased arrays (OPAs), and actuators that move the LIDAR chip, LIDAR adapter, and/or common support. Collimating lenses (not shown) can optionally be positioned in one or more locations selected from the group consisting of after the beam scanner 142, between the beam scanner 142 and the LIDAR chip and between the beam scanner 142 and the adapter in order to increase collimation of the system output signals.

The electronics can include a steering controller 143 configured to operate the one or more beam scanner 142 so as to steer the system output signal to different sample regions 144. The sample regions can extend away from the LIDAR system to a maximum distance for which the LIDAR system is configured to provide reliable LIDAR data. The sample regions can be stitched together to define the field of view. For instance, the field of view of for the LIDAR system includes or consists of the space occupied by the combination of the sample regions.

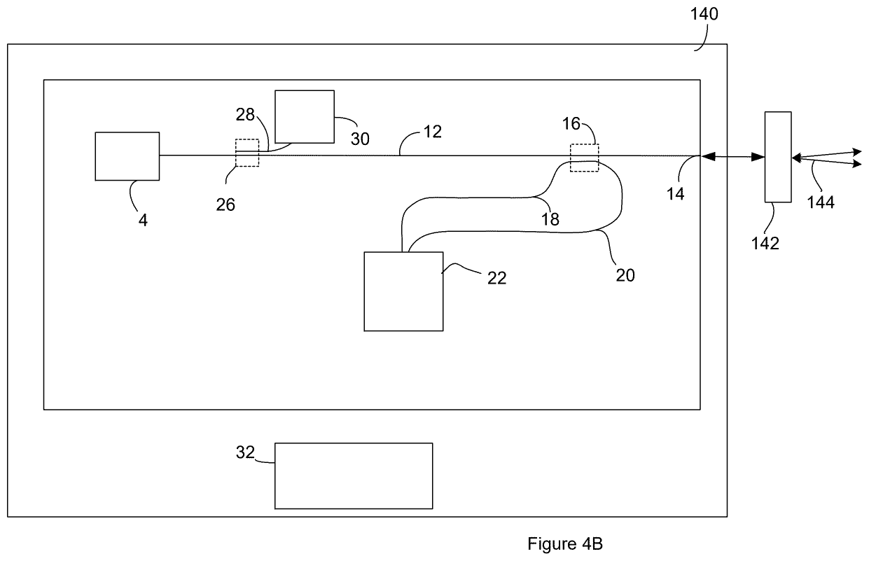

FIG. 5A through FIG. 5C illustrate an example of a suitable processing component for use as all or a fraction of the processing components selected from the group consisting of the processing component 22, the first processing component 46 and the second processing component 48. The processing component receives a comparative signal from a comparative waveguide 196 and a reference signal from a reference waveguide 198. The comparative waveguide 18 and the reference waveguide 20 shown in FIG. 1A and FIG. 1B can serve as the comparative waveguide 196 and the reference waveguide 198, the comparative waveguide 18 and the first reference waveguide 42 shown in FIG. 1C can serve as the comparative waveguide 196 and the reference waveguide 198, or the second comparative waveguide 50 and the second reference waveguide 44 shown in FIG. 1C can serve as the comparative waveguide 196 and the reference waveguide 198.

The processing component includes a second splitter 200 that divides the comparative signal carried on the comparative waveguide 196 onto a first comparative waveguide 204 and a second comparative waveguide 206. The first comparative waveguide 204 carries a first portion of the comparative signal to the signal combiner 211. The second comparative waveguide 208 carries a second portion of the comparative signal to the second signal combiner 212.

The processing component includes a first splitter 202 that divides the reference signal carried on the reference waveguide 198 onto a first reference waveguide 204 and a second reference waveguide 206. The first reference waveguide 204 carries a first portion of the reference signal to the signal combiner 211. The second reference waveguide 208 carries a second portion of the reference signal to the second signal combiner 212.

The second signal combiner 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal.

The second signal combiner 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include Germanium photodiodes (PDs), and avalanche photodiodes (APDs).

In some instances, the second signal combiner 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second signal combiner 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include Germanium photodiodes (PDs), and avalanche photodiodes (APDs).

The first signal combiner 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The first signal combiner 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the signal combiner 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the signal combiner 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second signal combiner 212 splits the second composite signal such that the portion of the comparative signal in the first portion of the second composite signal is phase shifted by 180° relative to the portion of the comparative signal in the second portion of the second composite signal, the signal combiner 211 also splits the composite signal such that the portion of the comparative signal in the first portion of the composite signal is phase shifted by 180° relative to the portion of the comparative signal in the second portion of the composite signal. When the second signal combiner 212 splits the second composite signal such that the portion of the reference signal in the first portion of the second composite signal is phase shifted by 180° relative to the portion of the reference signal in the second portion of the second composite signal, the signal combiner 211 also splits the composite signal such that the portion of the reference signal in the first portion of the composite signal is phase shifted by 180° relative to the portion of the reference signal in the second portion of the composite signal.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90-degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function, and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

In the LIDAR system disclosed in the context of FIG. 4A and FIG. 5A, the composite signals, the comparative signals, the LIDAR input signals, the system return signals, the system output signals, and the LIDAR output signals include light from the outgoing LIDAR signal. In the LIDAR system disclosed in the context of FIG. 4A and FIG. 5A, the composite signals, the comparative signals, the LIDAR input signals, the system return signals, and the system output signals include light from the LIDAR output signals. In the LIDAR system disclosed in the context of FIG. 4A and FIG. 5A, the composite signals, the comparative signals, the LIDAR input signals, and the system return signals include light from the system output signals. In the LIDAR system disclosed in the context of FIG. 4A and FIG. 5A, the composite signals, the comparative signals, and the LIDAR input signals include light from the system return signals. In the LIDAR system disclosed in the context of FIG. 4A and FIG. 5A, the composite signals, and the comparative signals, include light from the LIDAR input signals. In the LIDAR system disclosed in the context of FIG. 4A and FIG. 5A, the composite signals include light from the comparative signals.

The first light sensor 223 and the second light sensor 224 can be connected as a balanced detector and the first auxiliary light sensor 218 and the second auxiliary light sensor 220 can also be connected as a balanced detector. For instance, FIG. 5B provides a schematic of the relationship between the electronics, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 5B are included on the LIDAR chip. In some instances, the components illustrated in the schematic of FIG. 5B are distributed between the LIDAR chip and electronics located off the LIDAR chip.

The electronics connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data signal is an electrical representation of the first composite signal and the second data signal is an electrical representation of the second composite signal. Accordingly, the first data signal includes a contribution from a first waveform and a second waveform, and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e. the beating in the first composite signal and in the second composite signal.

The electronics 32 include a data processor 236 configured to generate LIDAR data for the sample regions. The data processor 236 includes a transformer 238 configured to perform a mathematical transform on the first data signal and the second data signal. For instance, the mathematical transform can be a complex Fourier transform with the first data signal and the second data signal as inputs. Since the first data signal is an in-phase component and the second data signal its quadrature component, the first data signal and the second data signal together act as a complex data signal where the first data signal is the real component and the second data signal is the imaginary component of the input.

The transformer 238 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The transformer 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The transformer 238 includes a transform component 268 that receives the complex data signal. For instance, the transform component 268 receives the first digital data signal from the first Analog-to-Digital Converter (ADC) 264 as an input and also receives the second digital data signal from the second Analog-to-Digital Converter (ADC) 266 as an input. The transform component 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of LIDAR input signal relative to the LIDAR output signal that is caused by the radial velocity between the reflecting object and the LIDAR chip.

The transformer 238 can include a peak finder (not shown) configured to identify peaks in the output of the transformer 238. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal and accordingly of the data signal.

The data processor 236 includes a LIDAR data generator 269 configured to receive the output from the transform component 268. For instance, the LIDAR data generator 269 can receive the beat frequency from the transform component 268. The LIDAR data generator 269 treats the frequency at the identified peak as the beat frequency of the comparative signal beating against all or a portion of a reference signal. The LIDAR data generator 269 can use the received beat frequencies in combination with the frequency pattern of the LIDAR output signals and/or the system output signals to generate LIDAR data results (distance and/or radial velocity between the reflecting object and the LIDAR chip or LIDAR system).

FIG. 5C shows an example of a relationship between the frequency of the system output signal, time, cycles and chirp periods. The base frequency of the system output signal (fₒ) can be the lowest frequency of the system output signal during a chirp period.

FIG. 5C shows frequency versus time for a sequence of two cycles labeled cycleⱼ and cycleⱼ₊₁. In some instances, the frequency versus time pattern is repeated in each cycle as shown in FIG. 5C. The illustrated cycles do not include re-location periods and/or re-location periods are not located between cycles. As a result, FIG. 5C illustrates the results for a continuous scan. Each cycle includes K chirp periods that are each associated with a period index k and are labeled DPₖ. Each sample region can be the portion of the field of view that is illuminated during the cycle that is used to generate the LIDAR data for the sample region. As a result, each of the LIDAR data results can be associated with one of the cycles and one of the sample regions.

In the example of FIG. 5C, each cycle includes two chirp periods labeled DPₖ with k=1 and 2. In some instances, the frequency versus time pattern is the same for the chirp periods that correspond to each other in different cycles as is shown in FIG. 5C. Corresponding chirp periods are chirp periods with the same period index. As a result, each chirp period DP₁ can be considered corresponding chirp periods and the associated frequency versus time patterns are the same in FIG. 5C. At the end of a cycle, the electronics return the frequency to the same frequency level at which it started the previous cycle.

During the chirp period DP₁, and the chirp period DP₂, the frequency of the system output signal is linearly chirped. For instance, the feedback loop can be configured to operate the light source such that the frequency of the system output signal changes at a linear rate a during the chirp periods DP₁ and DP₂. The direction of the frequency change during the chirp period DP₁ is the opposite of the direction of the frequency change during the chirp period DP₂.

The frequency output from the Complex Fourier transform represents the beat frequency of the composite signals that each includes a comparative signal beating against a reference signal. The beat frequencies (f_{LDP}) from two or more different chirp periods can be combined to generate the LIDAR data. For instance, the beat frequency determined from DP₁ in FIG. 5C can be combined with the beat frequency determined from DP₂ in FIG. 5C to determine the LIDAR data. As an example, the following equation applies during a chirp period where electronics increase the frequency of the outgoing LIDAR signal during the chirp period such as occurs in chirp period DP₁ of FIG. 5C: f_{ub}=−f_{d}+ατ where f_{ub} is the frequency provided by the transform component 268 (f_{LDP} determined from DP₁ in this case), f_{d} represents the Doppler shift (f_{d}=2νf_{c}/c) where f_{c} represents the optical frequency (fₒ), c represents the speed of light, ν is the radial velocity between the reflecting object and the LIDAR system where the direction from the reflecting object toward the LIDAR system is assumed to be the positive direction, and c is the speed of light. The following equation applies during a chirp period where electronics decrease the frequency of the outgoing LIDAR signal such as occurs in chirp period DP₂ of FIG. 5C: f_{db}=−f_{d}−ατ where f_{db} is a frequency provided by the transform component 268 (f_{i, LDP} determined from DP₂ in this case). In these two equations, f_{d} and τ are unknowns. These two equations can be solved for the two unknowns. The LIDAR data generator can calculate the radial velocity for the sample region from the Doppler shift (ν=c*f_{d}/(2f_{c})) and/or the separation distance for that sample region can be quantified from c*τ/2.

In some instances, more than one object is present in a sample region. In some instances when more than one object is present in a sample region, the transform may output more than one frequency where each frequency is associated with a different object. The frequencies that result from the same object in different chirp periods of the same cycle can be considered corresponding frequency pairs. LIDAR data can be generated for each corresponding frequency pair output by the transform. As a result, separate LIDAR data can be generated for each of the objects in a sample region.

The above LIDAR systems are disclosed in the context of a LIDAR system that calculates radial velocity for each sample region. However, when a LIDAR system is used in a quality control system, the calculation of radial velocity values may not be needed and/or desired. In these instances, it may be possible to generate the separation distance for each sample region from a single chirp period. As a result, each sample region may be associated with a single chirp period. Accordingly, the LIDAR data for each sample region may be generated from one or more chirp periods. In some instances, a workpiece may be vibrating or moving while in the evaluation space. When the LIDAR data includes radial velocity values, the radial velocity values can be used to correct for vibration and/or movement of the workpiece.

Although FIG. 5A through FIG. 5B illustrate signal combiners that combine a portion of the reference signal with a portion of the comparative signal, the processing component can include a single signal combiner that combines the reference signal with the comparative signal so as to form a composite signal. As a result, at least a portion of the reference signal and at least a portion of the comparative signal can be combined to form a composite signal. The combined portion of the reference signal can be the entire reference signal, or a fraction of the reference signal and the combined portion of the comparative signal can be the entire comparative signal or a fraction of the comparative signal.

As an example of a processing component that combines the reference signal and the comparative signal so as to form a composite signal, FIG. 5D through FIG. 5E illustrate the processing component of FIG. 5A through FIG. 5B modified to include a single signal combiner. The comparative waveguide 196 carries the comparative signal directly to the first signal combiner 211 and the reference waveguide 198 carries the reference signal directly to the first signal combiner 211.

The first signal combiner 211 combines the comparative signal and the reference signal into a composite signal. Due to the difference in frequencies between the comparative signal and the reference signal, the first composite signal is beating between the comparative signal and the reference signal. The first signal combiner 211 also splits the composite signal onto the first detector waveguide 221 and the second detector waveguide 222. The first detector waveguide 221 carries a first portion of the composite signal to the first light sensor 223 that converts the first portion of the second composite signal to a first electrical signal. The second detector waveguide 222 carries a second portion of the composite signal to the second light sensor 224 that converts the second portion of the second composite signal to a second electrical signal.

FIG. 5E provides a schematic of the relationship between the electronics, the first light sensor 223, and the second light sensor 224. The symbol for a photodiode is used to represent the first light sensor 223, and the second light sensor 224 but one or more of these sensors can have other constructions. In some instances, all of the components illustrated in the schematic of FIG. 5E are included on the LIDAR chip. In some instances, the components illustrated in the schematic of FIG. 5E are distributed between the LIDAR chip and electronics located off the LIDAR chip.

The electronics connect the first light sensor 223 and the second light sensor 224 as a first balanced detector 225. In particular, the first light sensor 223 and the second light sensor 224 are connected in series. The serial connection in the first balanced detector is in communication with a first data line 228 that carries the output from the first balanced detector as a first data signal. The first data signal is an electrical representation of the composite signal.

The electronics 32 include a transformer 238 configured to perform a mathematical transform on the first data signal. The mathematical transform can be a real Fourier transform with the first data signal as an input. The electronics can use the frequency output from the transform as described above to extract the LIDAR data.

Each of the balanced detectors disclosed in the context of FIG. 5A through FIG. 5E can be replaced with a single light sensor. As a result, the processing component can include one or more light sensors that each receives at least a portion of a composite signal in that the received portion of the composite signal can be the entire composite signal or a fraction of the composite signal.

As discussed in the context of FIG. 5C, the electronics 32 tune the frequency of the system output signal. One example of a method to produce this frequency chirp is to modulate the electrical current applied to the light source by the electronics. In semiconductor lasers that can be used as the light source in the LIDAR system, current modulation results in frequency modulation via nonlinear carrier/photon coupling.

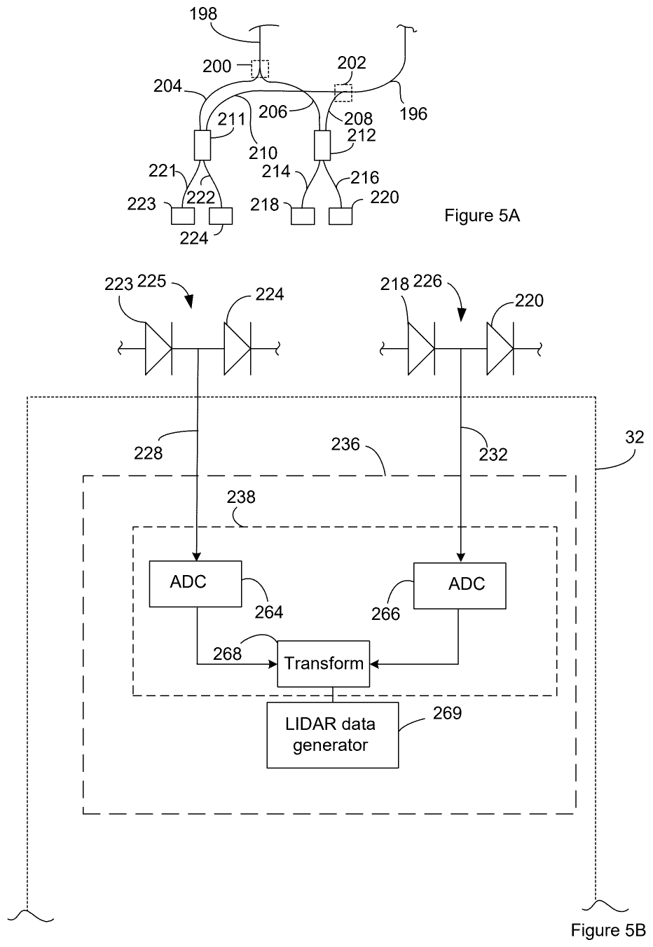

FIG. 6 is a schematic of an example of a beam scanner 124 suitable for use with a LIDAR assembly. The beam scanner 124 includes a polygon mirror 302 and a movable mirror 304. The polygon mirror 302 is arranged such that the LIDAR output signal transmitted from the LIDAR assembly is received by the polygon mirror 302 and is then output from the polygon mirror 302. The movable mirror 304 is arranged such that the movable mirror 304 receives the LIDAR output signal from the polygon mirror 302 and transmits the received LIDAR output signal. In the embodiment of FIG. 6, the portion of the LIDAR output signal output from the movable mirror 304 serves as the system output signal for the LIDAR. The relative positions of the polygon mirror 302 and the movable mirror 304 can be reversed. For instance, the movable mirror 304 and polygon mirror 302 can be arranged such that the movable mirror 304 receives the LIDAR output signal from the polygon mirror 302, the polygon mirror 302 receives the LIDAR output signal from the movable mirror 304, and the portion of the LIDAR output signal output from the polygon mirror 302 serves as the system output signal for the LIDAR system.

The polygon mirror includes multiple surfaces arranged in a polygon configuration. The surfaces of the polygon mirror can be reflective. For instance, the surfaces of the polygon mirror can be mirrored surfaces. Suitable movable mirrors 304 include, but are not limited to, micro-electromechanical (MEMS) mirrors, galvo-scanners, galvo-mirrors, voice coil driven mirrors, and Permanent Magnet Synchronous Motor (PMSM) mirrors.

The steering controller 143 can operate the polygon mirror 302. For instance, the steering controller 143 can operate an actuator (not shown) so as move the polygon mirror 302. An optional revolution mode for the polygon mirror 302 can be illustrated by the arrow labeled B in FIG. 6. In the revolution mode, the steering controller 143 can operate an actuator so as to rotate the polygon mirror around an axis of rotation for the polygon mirror. The rotation can be more than 360° of rotation the axis of rotation. For instance, the rotation can include one or more full rotations of the polygon mirror around the axis. Accordingly, the polygon mirror can be rotated such that the LIDAR output signal is repeatedly incident on more than one of the surfaces of the polygon mirror.

The steering controller 143 can operate the polygon mirror 302 in an oscillation mode. The second rotation mode can be illustrated by the arrow labeled B in FIG. 6. In the oscillation mode, the steering controller 143 can operate the actuator so as to rotate the polygon mirror around the axis of rotation for less one or more partial revolutions that are each where sequential partial revolutions are in opposite directions. Accordingly, each partial revolution can rotate the polygon mirror 302 less than 360° of rotation around the axis of rotation and sequential partial revolutions can alternate rotations in a positive rotation direction and with rotations in a negative rotation direction that is the reverse of the positive rotation direction. The angular range over which the polygon mirror 302 is rotated during each partial revolution in a sequence of partial revolutions can be constant although other configurations are possible. As an example of a polygon mirror 302 operated in an oscillation mode is the polygon mirror 302 being rotated by +α°, followed by being rotated by −α°, followed by being rotated by +α°, followed by being rotated by −α° . . . . In this example, the angle α can represent the range of angles over which the polygon mirror 302 is rotated during a partial revolution.

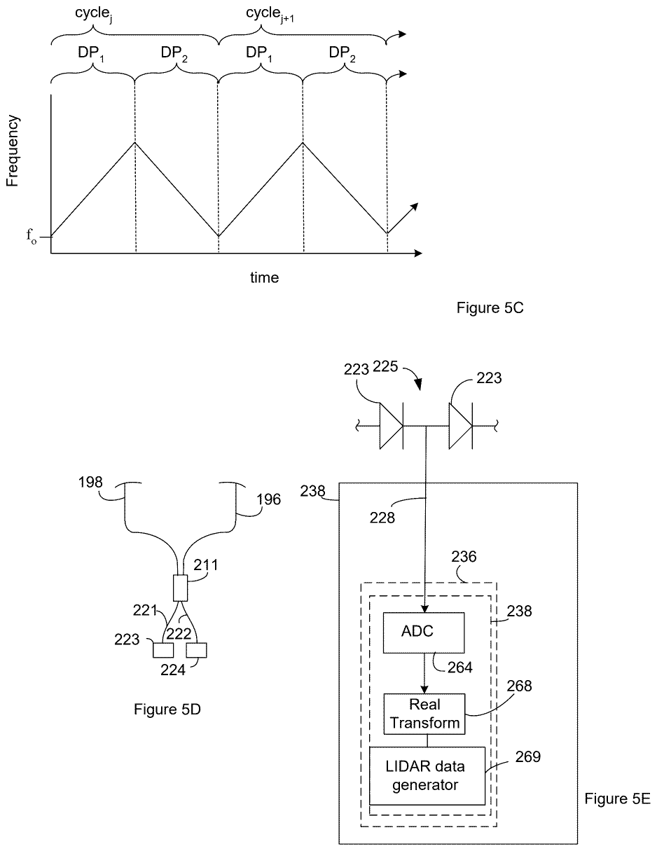

FIG. 7 is a schematic of the relationship between a LIDAR system and the field of view for the LIDAR system. The field of view is represented by the dashed lines that extend from the LIDAR system to an imaginary surface within the field of view. In order to show the extent of the field of view, the imaginary surface is positioned at a maximum operational distance (labeled dm) from the LIDAR system. The maximum operational distance can generally be considered the maximum distance for which the LIDAR system is configured to provide reliable LIDAR data. In reality, the imaginary surface can have a curved shape due to the fixed nature of the maximum operational distance, however, a planar surface is shown to simplify the following discussion.

As noted above, the steering controller 143 can operate the beam scanner 124 to steer the system output signal to different sample regions 144 in the field of view. A portion of a sample region 144 is illustrated by the rectangle on the plane of FIG. 7. Only a portion of the illustrated sample region 144 is shown as illuminated by the system output signal because the system output signal can continue to be scanned during the chirp period(s) associated with the sample region 144. For instance, the system output signal in FIG. 7 can be scanned in the direction of the arrow labeled A for the duration of a cycle. This scan can cause the system output signal to illuminate the length of the plane labeled ct during the cycle. The sample regions can serve as three-dimensional pixels that can be stitched together to provide a three-dimensional image of all, or a portion, of the field of view.

The beam scanner 124 is disclosed in the context of a beam scanner 124 that includes a polygon mirror 302 and a movable mirror 304; however, other beam scanner configurations are possible. For instance, a beam scanner 124 can include more than one polygon mirror 302 and more than one movable mirror 304. Further, a movable mirror configured to scan one or more system output signals in two dimensions can serve as a suitable beam scanner 124. Other suitable beam scanner configurations can include or consist of one or more components selected from the group consisting of phased arrays, optical switches, focal plane arrays, and optical phased arrays.

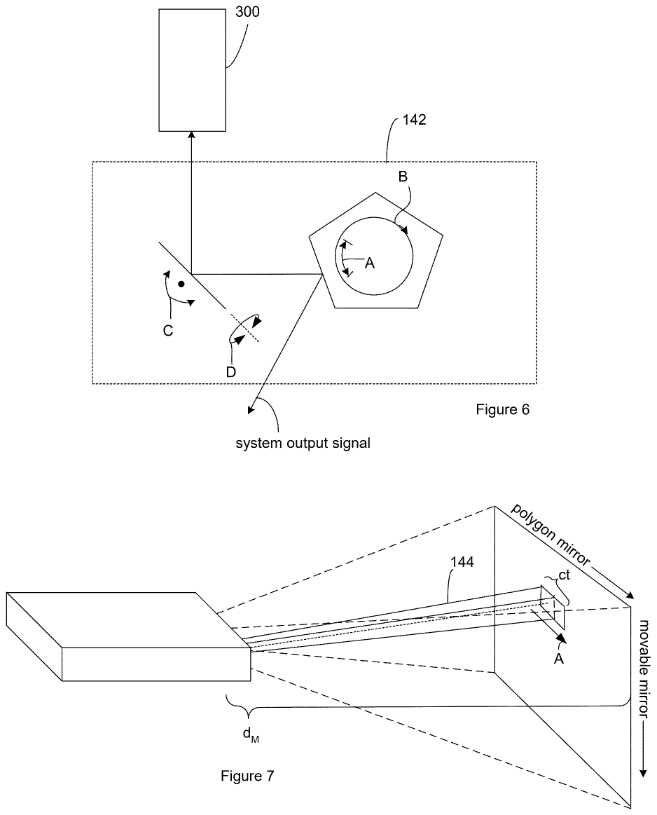

FIG. 8 illustrates a quality control system. The quality control system includes a workpiece support 340 configured to receive a workpiece (not shown). A workpiece (not shown) can be held in place on the workpiece support by one or more immobilization mechanisms (not shown) or can be rested on the workpiece support without the use of immobilization mechanisms. Suitable immobilization mechanisms include, but are not limited to, clamps, magnets, and straps. Suitable workpiece supports include, but are not limited to, desktops, tabletops, and conveyor belts. The workpiece support need not be a flat surface. For instance, the workpiece support can be a conveyor with hooks that each carry a workpiece into the evaluation space. Conveyors can stop and hold each workpiece within the evaluation space for a period of time before moving the workpiece out of the evaluation space. In another example, the workpiece support is mounted on one or more robotic arms. For instance, the workpiece support can be one or more components selected from a group consisting of grippers, clamps, and robot end effectors that are configured to hold the workpiece within the evaluation space.

The quality control system includes a preliminary camera 342 and a LIDAR system 344 that are held in position relative to the workpiece support 340. For instance, the quality control system can include one or more supports 345 that hold the preliminary camera 342 and LIDAR system 342 in a desired position relative to the workpiece support 340. In some instances, the one or more supports 345 also hold the preliminary camera 342 in a desired position relative to the LIDAR system 344.

The preliminary camera 342 is configured to generate two-dimensional image data for one or more objects in a three-dimensional evaluation space 346 illustrated by the dashed lines in FIG. 8. The interface of the evaluation space 346 with the workpiece support 340 is labeled “P” in FIG. 8. The preliminary camera 342 can include a multipixel sensor that receives light from the evaluation space 346 during operation of the preliminary camera 342. In some instances, the sensor is a focal plane sensor. In some instances, the preliminary camera 342 is configured to use output from the sensor to generate two-dimensional image data for the evaluation space 346 and/or for one or more objects in the evaluation space 346. In some instances, the two-dimensional image data is sufficient for electronics to use the two-dimensional image data for the evaluation space 346 to generate a two-dimensional image that provides a visual representation of the contents of the evaluation space; however, the preliminary camera 342 need not actually generate a visible version of a two-dimensional image for operation of the quality control system. Suitable preliminary cameras 342 include, but are not limited to, RGB cameras and BW cameras and other two-dimensional focal plane array imagers or two-dimensional focal plane array cameras.

Different positions, or locations, within the evaluation space can be described using an evaluation space coordinate system as illustrated by the axes labeled x, y, and z in FIG. 8. Although Cartesian coordinates are illustrated in the evaluation space of FIG. 8, other coordinate systems can be employed to describe positions within the evaluation space. In some instances, the evaluation space is defined by a spherical coordinate system (not shown). The spherical coordinate system can be arranged such the polar angle and the azimuthal angle can be used to define the direction that the system output signals travel away from the LIDAR system. In some instances, the evaluation space is defined by a spherical coordinate system with the origin of the spherical coordinate system at the same location as the origin of the evaluation space coordinates. For instance, in some instances, the evaluation space is defined by a spherical coordinate system with the origin of the spherical coordinate system at the same location as a Cartesian coordinate system that serves as the evaluation space coordinate system.

The quality control system can include quality control electronics 381 that include preliminary camera electronics 347 and the electronics 32. The preliminary camera electronics 347 can store and/or process the output from the sensor and/or the image data and can store the image data in a digital file. The preliminary camera electronics 347 can include one or more storage devices 348 that can retain data to be accessed by a processor 349. Suitable processors 349 include, but are not limited to, image processors such as image processing engines, image processing units (IPU), or image signal processors (ISP), and specialized digital signal processor (DSP) used for image processing. In some instances, the processor 349 is an image processor that includes a readout integrated circuit (readout IC) configured to read and process output from a focal plane array that serves as the sensor. The storage device can include non-volatile memory and/or volatile memory. Suitable storage devices include, but are not limited to, one or more devices selected from the group consisting of DRAM, SRAM, and flash memory. Suitable digital file formats include, but are not limited to, compressed file formats such as JPEG, PNG, GIF, and uncompressed raw image files where an unprocessed set of pixel data is stored directly from the camera's sensor such as a Digital Negative (DNG) file. When the processor 349 does not run an operating system such as Linux, the image file can be a collection of arrays and/or vectors in the one or more storage devices 348.

The LIDAR systems described above are examples of LIDAR systems that are suitable for use in the quality control system, however, other LIDAR system configurations are possible. The LIDAR system is configured to scan at least one system output signal 350 to a series of sample regions 144 in a field of view 354. While a near-field portion of the field of view closest to the LIDAR system can be outside of the evaluation space 346 as shown in FIG. 8, the field of view can include a far-field portion that is further from the LIDAR system. For instance, the near-field portion of the field of view can be between the far-field portion of the field of view and the LIDAR system. In some instances, the field of view does not include the near-field portion, and the far-field portion serves as the field of view 354. The far-field portion of the field of view 354 can be within the evaluation space 346. The far-field portion of the field of view 354 can have the same perimeter as the perimeter of the evaluation space 346 shown in FIG. 8. Alternately, one or more portions of the far-field portion of the field of view can extend beyond the evaluation space 346.

The field of view 354 can include one or more regions of interest. For instance, the field of view 354 shown in FIG. 8 includes a region of interest 370 (ROI 370). Each region of interest can have a volume or area that occupies a fraction of the field of view. As a result, the area of the region of interest shown on the workpiece support 340 of FIG. 8 is smaller than the area of the field of view shown on the workpiece support 340 of FIG. 8. Although the regions of interest are shown as being spaced apart, different regions of interest can overlap.

The LIDAR system is configured to scan the one or more regions of interest 370 within the field of view. For instance, the LIDAR system is configured to direct the one or more system output signals to a series of sample regions within a ROI 370. As an example, FIG. 8 illustrates the ROI 370 as having multiple sample regions 144. The steering controller 143 can operate the one or more beam scanner 142 so as to steer the system output signal to different sample regions 144 within the ROI 370. The pattern of sample regions within the ROI 370 can indicate the scan pattern for a system output signal within the ROI 370. The LIDAR system can calculate LIDAR data for each, or a portion, of the sample regions 144 in each of the regions of interest 370 within a field of view. For instance, the LIDAR data generator can calculate LIDAR data for each, or a portion, of the sample regions 144 in each of the regions of interest 370 within a field of view.

In some instances, the portions of the field of view outside of the one or more regions of interest are not substantively scanned by a system output signal. For instance, in some instances, the LIDAR system does not generate LIDAR data for the portion(s) of the field of view outside of the one or more regions of interest within the field of view. Reducing the scanning and LIDAR data generation to the regions of interest rather than the entire field of view reduces the time needed to scan each of the workpieces.

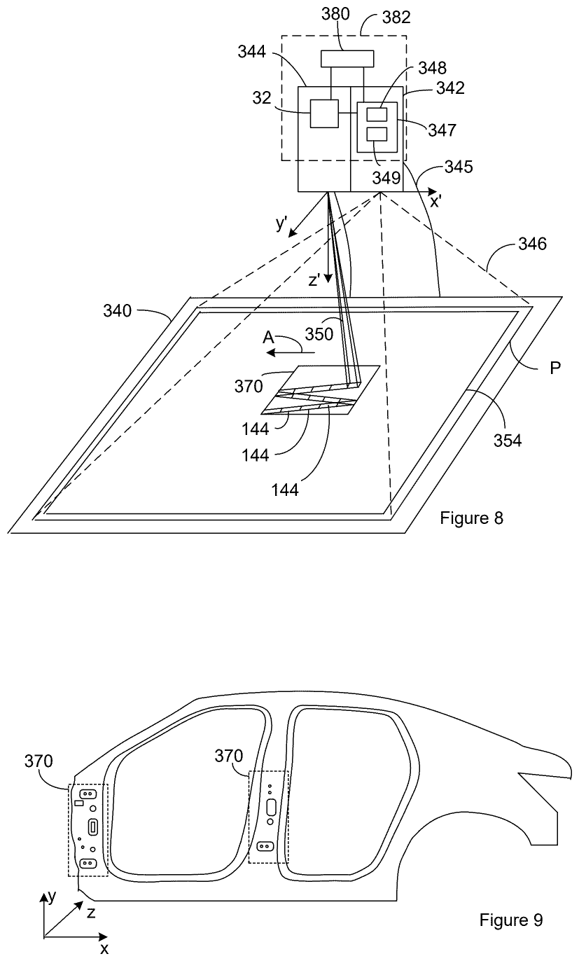

FIG. 9 is a topview of a model of a workpiece 362. For the purposes of illustration, the illustrated workpiece is part of an automobile frame although other workpieces can be used. Other examples of suitable workpieces include, but are not limited to, parts where it is desirable that for multiple of the same part to retain a consistent geometry across the multiple parts.

FIG. 9 shows the location of multiple regions of interest 370 on the model. Typical regions of interest are regions of interest where a high degree of accuracy is needed in the shape, size or relative positions of different features of portion of the workpiece within the one or more regions of interest within the workpiece.

A model workpiece can be a workpiece having a geometry against which the geometry of other workpieces is compared. The workpieces that are compared to the model workpiece can serve as workpieces. The quality control system can compare the geometry of each of one or more trial pieces to the geometry of the model to evaluate the workpiece. For instance, the quality control system can compare the geometry of each of one or more workpieces to the geometry of the model to evaluate the degree to which the geometry of the workpiece matches the geometry of the model. The geometry of the model and the workpieces can include one or more components selected from the group consisting of the dimensions and shape of the workpiece, the dimensions and shape of features of the workpiece, the location of features on the workpiece, the distance between features on the workpiece. Examples of features on a workpiece include, but are not limited to, curves in edges and surfaces, recesses, projections, openings, holes, compressions, and curvature of surfaces.

The model workpiece need not be a tangible, solid workpiece but can be represented in a computer file that serves as a model file. An example of a model file is a Computer-Aided Design file (CAD file) such as a Standard for the Exchange of Product model data file (STEP file, ISO1303). A STEP file typically uses a mathematical representation called NURBS (Non-Uniform Rational B-Splines) to define the geometry of a 3D model and/or a 2D model. A STEP also can include other data about the model workpiece. Examples of data contained in a STEP file include, but are not limited to, geometric data such as locations of points, curves, surfaces and solids, and topological data such as relationships between geometric entities such as vertices, edges, and faces. While STEP files use a vector-based representation of the geometry of the model, a suitable model file can define the geometry of the model workpiece using other representations such as pixel and/or point cloud representations.

The model file can make use of a model space having a coordinate system that describes locations within the model space. Accordingly, a location on the surface of a model within the model space can be described using the model space coordinates. As an example, when the model space coordinate system is a Cartesian coordinate system, locations within the model space can be represented by (x, y, z).

The model file also includes the locations of the one or more regions of interest 370 on the model workpiece. The locations of the one or more regions of interest 370 on the model workpiece can be identified in the model file by the locations of the vertices of each of the one or more regions of interest 370 on the model workpiece. Alternately, the locations of the one or more regions of interest 370 on the model workpiece can be indicated by the locations of pixels or point cloud points that fall within each of the regions of interest 370. The location of the one or more regions of interest 370 on the model workpiece can be entered into the model file by an operator using a CAD program. The model file can be stored in the one or more storage devices 348 included in the preliminary camera electronics 347. Before operation of the quality control system, the model file can be loaded into the one or more storage devices 348.

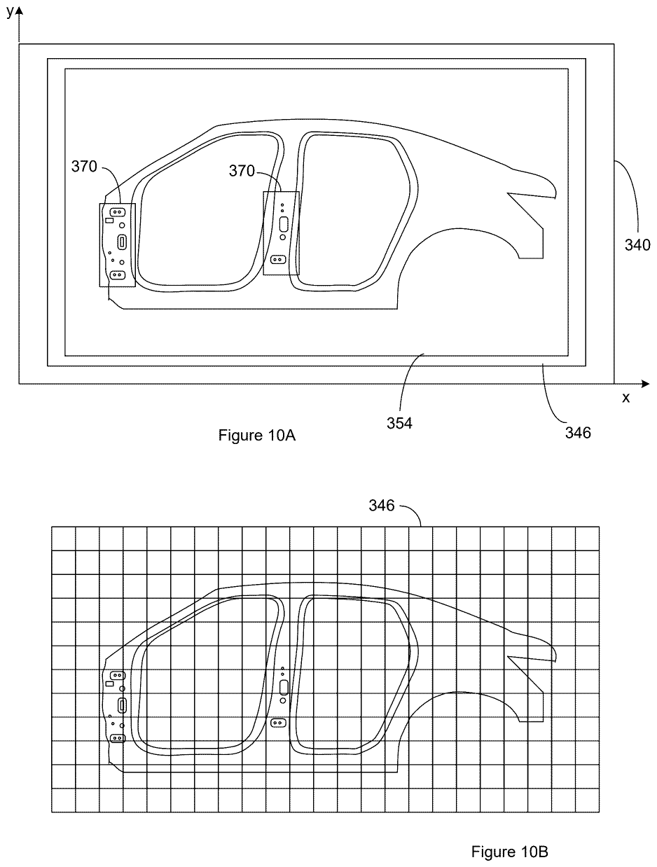

In order to have the quality control system evaluate a workpiece, a workpiece is positioned on the workpiece support 340 within the field of view 354 and within the evaluation space 346. For instance, FIG. 10A illustrates a workpiece 362 positioned on the workpiece support 340 of FIG. 8 within the field of view 354 and within the evaluation space 346. The preliminary camera 342 can be operated so as to generate a trial image file of the workpiece. In some instances, the trial image file is an image file for a two-dimensional image. The trial image file includes image data that electronics could use to create and display a visual image of the workpiece. The image of the workpiece can be divided into pixels. As an example, FIG. 10B illustrates an image of the workpiece of FIG. 10A divided into trial pixels. In order to simplify the illustration, the trial pixels are shown as large relative to the image of the workpiece. The image data can include data associated with all or a portion of the different trial pixels. For instance, the image data can include an image coordinate system. The image data can use the image coordinate to define the location of each pixel within the image and/or the locations of the pixels relative to one another. In some instances, the image coordinate system is a two-dimensional coordinate system. For the purposes of illustration, the trial image in FIG. 10B shows the trial pixels relative to Cartesian coordinates that can serve as the image coordinates with axes labeled “x” and “y.” As a result, the image data can include Cartesian coordinate associated with each trial pixel. In some instances, the trial image data can include row and column numbers that are associated with each pixel and that serve as Cartesian coordinates. Although the pixel locations are described in the context of a Cartesian coordinate system, other coordinate systems can be used. As a result, the image data can associate each, or a portion, of the trial pixels, with coordinates that define the locations of each trial pixel within the trial image and/or the locations of the trial pixels relative to one another. The processor 349 can store the image in the one or more storage devices 348 included in the preliminary camera electronics 347. The image data can include data in addition to the coordinate data. For instance, the model image data can associate each, or a portion, of the model pixels, with brightness or intensity. In some instances, the image data associates each, or a portion, of the model pixels with data in addition to the coordinates and brightness or intensity. For instance, the image data can associate each, or a portion, of the model pixels with color data in addition to the coordinates and brightness or intensity.

The processor 349 generates a transform for transforming points in the model space to corresponding points in the evaluation space. Generation of the transform can include the preliminary camera electronics 347 determining a pose of the camera relative to the model in the model space. In some instances, the processor 349 determines the pose of the camera relative to the model in the model space. For instance, the processor 349 can compare the image of the workpiece in the image file to the model in the model file so as to determine the position and orientation that the preliminary camera 342 would occupy in the model in order for the preliminary camera 342 to generate an image of the model that matches the image of the workpiece in the image file. The combination of translation and orientation for an object can be considered the pose of the object. As a result, in some instances, the processor 349 determines the pose of the preliminary camera 342 within the model space where the preliminary camera 342 would generate an image of the model that approximates the image of the workpiece in the image file. In some instances, the processor 349 uses a pose estimation algorithm and/or a camera pose estimation algorithm to determine the pose of the preliminary camera 342 within the evaluation space. In an example pose estimation algorithm and/or a camera pose estimation algorithm, the processor 349 extracts features of the workpiece from the image file. Examples of features that can be extracted include, but are not limited to, edges, corners, and contours of the workpiece. The processor 349 matches the extracted features to corresponding features on the model in the model file. The processor 349 uses the positions of the matched features to estimate the “pose” (orientation and position) of the preliminary camera within the model space that would cause the preliminary camera 342 to produce a two-dimensional image of the model that would match the image in the image file. In some instances, the processor 349 uses an algorithm such as Perspective-n-Point (PNP) and/or Iterative Closest Point (ICP) to estimate the “pose” (orientation and position) of the preliminary camera 342 within the model space.

Pose can be expressed by the combination of a translation vector and rotational matrix. In some instances, the translation vector is a 1×3 translation vector and the rotation matrix is a 3×3 rotation matrix. The translation vector from point “a” to “b” can be expressed as pₐ^{b} and the level of rotation from point a to b can be expressed as Rₐ^{b}. A transformation matrix that represents the translation and rotation from point “a” to “b” can be expressed as follows:

$${T}_{a}^{b} = [ \begin{matrix}{R}_{a}^{b} & {p}_{a}^{b} \\ 0 & 1\end{matrix} ] .$$

Since the translation vector can be a 1×3 translation vector and the rotation matrix can be a 3×3 rotation matrix, the transformation matrix can be expanded to show the elements of the translation vector and rotation as follows:

$${T}_{a}^{b} = [ \begin{matrix}{r}_{11} & {r}_{12} & {r}_{13} & x \\ {r}_{21} & {r}_{22} & {r}_{23} & y \\ {r}_{31} & {r}_{32} & {r}_{33} & z \\ 0 & 0 & 0 & 1\end{matrix} ]$$

where r₁₁ through r₃₃ represent the elements of the rotation matrix and x, y, z represent the elements of the translation vector. This transformation matrix format is an example of a homogeneous transformation matrix, however, other transformation matrix formats can be employed.

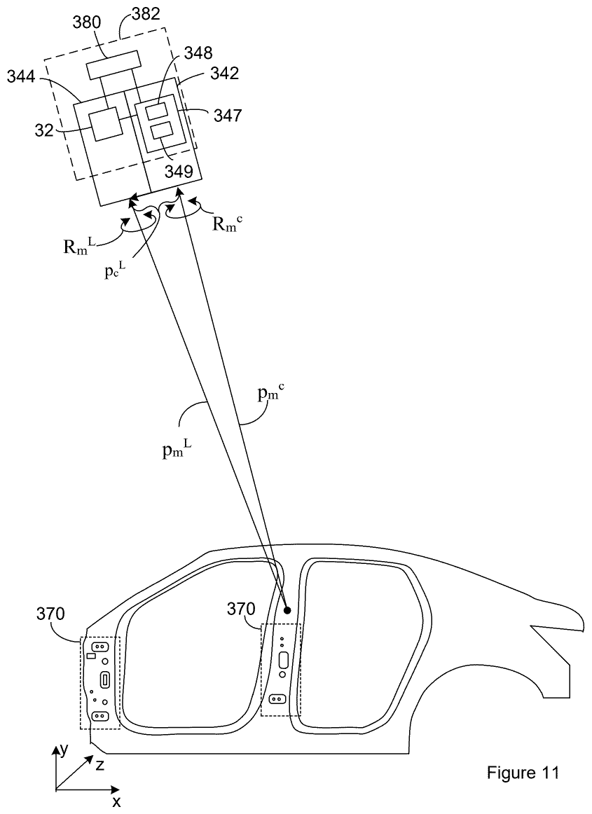

The “pose” for the preliminary camera 342 within the model space can be expressed as pₘ^{c} and Rₘ^{c} and/or as the transformation matrix Tₘ^{c} where pₘ^{c} represents the translation vector from the model to the preliminary camera, Rₘ^{c} represents the rotation of the preliminary camera relative to the model, and Tₘ^{c} represents the transformation matrix from the preliminary camera relative to the model. In order to illustrate the principles of calculating the pose of the preliminary camera 342 and the LIDAR system relative to the model, FIG. 11 shows the preliminary camera 342 and the LIDAR system 344 relative to the model in the model space. A representation of the translation vector from the model to the preliminary camera is labeled pₘ^{c} and a representation of the rotation of the preliminary camera relative to the model is labeled Rₘ^{c}. The transformation matrix Tₘ^{c} can be generated from the translation vector and the rotation matrix.

The preliminary camera electronics 347 can convert the pose of the camera relative to the model in the model space to a pose of the LIDAR system relative to the model in the model space. In some instances, the processor 349 converts the pose of the camera relative to the model in the model space to a pose of the LIDAR system relative to the model in the model space. The “pose” of the LIDAR system 344 relative to the preliminary camera 342 is a known result of the construction of the quality control system and can be expressed as p_{L}^{c} and R_{c}^{L} and/or as the transformation matrix T_{c}^{L} where pc-represents the translation vector from the preliminary camera to the LIDAR system, R_{c}^{L} represents the rotation of the LIDAR system relative to the preliminary camera, and T_{c}^{L} represents the transformation matrix for the LIDAR system relative to the preliminary camera. In FIG. 11, a representation of the translation vector from the preliminary camera to the LIDAR system is labeled p_{c}^{L}. A representation of the rotation matrix for rotation of the LIDAR system relative to the preliminary camera (R_{c}^{m}) is not labeled in FIG. 11 to reduce image complexity. The transformation matrix Tom can be generated from the translation vector and the rotation matrix.

The pose of the LIDAR system relative to the model in model space can be expressed as pₘ^{L} and Rₘ^{L} and/or as the transformation matrix Tₘ^{L} where pₘ^{L} represents the translation vector from the model to the LIDAR system, Rₘ^{L} represents the rotation of the LIDAR system relative to the model, and Tₘ^{L} represents the transformation matrix for the LIDAR system relative to the model. In FIG. 11, a representation of the translation vector from the model to the LIDAR system is labeled pₘ^{L} and a representation of the rotation of the LIDAR system relative to the model is labeled Rₘ^{L}. The transformation matrix Tₘ^{L} can be generated from the translation vector and the rotation matrix. The processor 349 can calculate the pose of the LIDAR system relative to the model from the “pose” for the preliminary camera 342 relative to the model and the “pose” of the LIDAR system 344 relative to the preliminary camera 342. For instance, the transformation matrix Tₘ^{L} can be calculated from Tₘ^{L}=Tₘ^{c}*T_{c}^{L}. As a result, the processor 349 can use Tₘ^{L}=Tₘ^{c}*T_{c}^{L} to convert the pose of the camera relative to the model in the model space to a pose of the LIDAR system relative to the model in the model space.

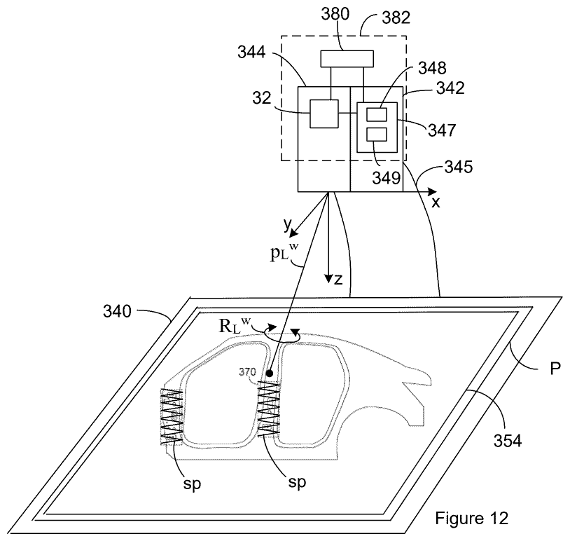

The pose of the LIDAR system relative to the workpiece in the evaluation space can be expressed as p_{L}^{w} and R_{L}^{w} and/or as the transformation matrix T_{L}^{w} where p_{L}^{w} represents a translation vector from the LIDAR system to the workpiece in the evaluation space, R_{L}^{w} represents the rotation of the workpiece relative to the LDAR system, and T_{L}^{w} represents the transformation matrix for the pose of the workpiece relative to the LIDAR system. FIG. 12 illustrates the quality control system of FIG. 8 with the workpiece of FIG. 10A positioned in the evaluation space. A representation of the translation vector from the LIDAR system to the workpiece is labeled p_{L}^{w} and a representation of the rotation of the LIDAR system relative to the model is labeled R_{L}^{w}. Because the geometry of the workpiece approximates the shape of the model, the pose of the LIDAR system relative to the model in the evaluation space approximates the pose of the LIDAR system relative to the workpiece in the evaluation space. As a result, the transformation matrix T_{L}^{w} can be the inverse of the transformation matrix Tₘ^{L}. For instance, T_{L}^{w}=[Tₘ^{L}]⁻¹. The values of p_{L}^{w} and R_{L}^{w} can be extracted from the transformation matrix T_{L}^{w}. The p_{L}^{w}, R_{L}^{w} and T_{L}^{w} can represent approximations since the geometry of the workpiece may be different from the geometry of the model.

The model space coordinates and the evaluation space coordinates measure positions relative to a physical space. For instance, in the model space, an increase in coordinate x from x=1 to x=2 can correspond to an increase in distance of 1 cm. When the distance per coordinate increments are the same for each of the coordinates in the model space coordinates and the evaluation space coordinates, the pose provided by T_{L}^{w}=[Tₘ^{L}]⁻¹ can serve as the approximation for the pose of the LIDAR system relative to the workpiece in the evaluation space, However, when the distance per coordinate increment for one or more coordinates in the model space are different from the corresponding coordinate in the evaluation space coordinates, the pose provided by T_{L}^{w}=[Tₘ^{L}]⁻¹ Can be corrected for the change in coordinate dimensions between the model space and the evaluation space.

The transformation matrix T_{L}^{w} can serve as a coordinate transformation matrix that can be used in a transform from the model space to the evaluation space. For instance, points in the model space can be transformed to corresponding points in the evaluation space by multiplying T_{L}^{w} by the model space coordinates for the point. As an example, when the model space coordinate system is a Cartesian coordinate system, a location in the model space can be represented by (x, y, z) and when the evaluation space coordinate system is a Cartesian coordinate system, a location in the evaluation space can be represented by (x′, y′, z′), the processor 349 can convert the model space coordinates to corresponding evaluation space using: (x′, y′, z′, 1)=T_{L}^{w}.*(x, y, z, 1). Accordingly, a location on the surface of the model described in model space coordinates can be transformed to a corresponding location in the evaluation space.

The translation vectors can be measured relative to a particular feature on the model or the workpiece. For instance, a translation vector can start or end at a feature on the model or the workpiece such as the center of the model or workpiece, the centroid of the model or workpiece, a corner of the model or workpiece, or other feature on the model or workpiece. As an example, the translation vector represented by p_{L}^{w} in FIG. 11 can start at the centroid of the model.

The processor 349 uses the ability to transform between model space coordinates and evaluation space coordinates to transform the locations of the regions of interest in model space to the evaluation space. For instance, the processor 349 can apply the transform to model space coordinates set forth in the model file for vertices of the one or more regions of interest 370 on the model workpiece. The resulting evaluation space coordinates identify the locations of the region(s) of interest in the evaluation space. Alternately, the processor 349 can apply the transform to model space coordinates set forth in the model file for pixels or point cloud points that fall within the regions of interest. The perimeter of the resulting evaluation space coordinates identifies the location of the region(s) of interest in the evaluation space. Since the transform between the model space and the evaluation space transforms a location in the model space to a corresponding location in the evaluation space, the location of the region of interest within the evaluation space relative to the workpiece approximates, or corresponds to, the location of the region of interest relative to the model in the model space. Accordingly, the regions of interest 370 shown on the model of FIG. 9 are shown transformed into the evaluation space of FIG. 12. Since the regions of interest shown in FIG. 9 are generated by transformation from the model space coordinates to evaluation space coordinates, the positions of the regions of interest 370 relative to the workpiece of FIG. 12 corresponds to the positions of the regions of interest 370 relative to the model of FIG. 9.

The electronics 32 can receive the location of the region(s) of interest in the evaluation space from the preliminary camera electronics 347. The LIDAR system 344 can scan the system output signal within each of the one or more regions of interest within the evaluation space. For instance, the steering controller 143 can operate the beam scanner 124 to steer the system output signal to a series of different sample regions 144 in each region of interest 370 defined by the position and orientation of each region of interest 370 received from the preliminary camera electronics 347. As an example, the regions of interest 370 shown in FIG. 12 include lines labeled SP that each illustrates an example of a scan pattern for a system output signal within each region of interest. For instance, the steering controller 143 can operate the beam scanner 124 to steer the system output signal to a series of sample regions 144 that collectively define the scan patterns shown in FIG. 12. Since the location of the region of interest within the evaluation space relative to the workpiece approximates, or corresponds to, the location of the region of interest relative to the model in the model space, scanning the system output signal within the region of interest in the evaluation space effectively scans the portion of the workpiece that corresponds to the portion of the model within the region of interest in the model space.

The steering controller 143 can operate the beam scanner so as to control the number, density and/or spatial pattern of sample regions within each region of interest 370. For instance, the steering controller 143 can adjust the scan speed of the system output signal so as to provide each region of interest 370 with the number, density and spatial pattern of sample regions within each region of interest 370. For instance, in a beam scanner 124 constructed according to FIG. 6, the steering controller 143 can adjust the scan speed of the polygon mirror 302 and movable mirror 304 so as to provide the number, density and spatial pattern of sample regions desired within each region of interest 370. In some instances, the number of sample regions in a region of interest is associated with a target number or a range of target numbers, the density of sample regions in a region of interest is associated with a target density or a range of target densities, and/or the pattern of sample regions in a region of interest is associated with a target pattern. Accordingly, in some instances, the steering controller 143 identifies the scan pattern within each region of interest that provides one or more features selected from a group consist of: the number of sample regions in a region of being at the target number or within the range of target numbers, the density of sample regions in the region of interest being at the target density or within the range of target densities, and the pattern of sample regions in the region of interest having the target pattern. The steering controller 143 can operate the beam scanner 124 so the system output signal has the identified scan pattern.

The scan pattern can alternatively be identified in the model file. For instance, the model file can identify the scan pattern for each region of interest. As an example, all or a portion of the sample regions to be scanned in each region of interest can each be associated with the location of the sample region at the surface of the model. The locations can be expressed in model space coordinates. The processor 349 can use the coordinate transform matrix to transform the locations of the sample regions from model space coordinates to their corresponding locations in evaluation space coordinates. The steering controller 143 can receive the locations of the sample regions in evaluation space coordinates from the processor 349. The received locations can define the scan pattern in that the steering controller 143 can identify a scan pattern that includes, or consists of, the locations of the received sample regions. For instance, the steering controller 143 can cause the system output signal to be scanned in a pattern where the system output signal is sequentially directed toward the locations of the received sample regions.

The scan pattern in the evaluation space can be defined using evaluation space coordinates and/or spherical coordinates. When a scan pattern is defined using one or more locations described in evaluation space coordinates, the evaluation space coordinates can be converted to spherical coordinates using common coordinate transformations from the evaluation space coordinates to the spherical coordinates. For instance, the steering controller 143 convert the locations described in evaluation space coordinates to spherical coordinates. Since the polar angle and the azimuthal angle of the spherical coordinates can define the direction that the system output signals travel away, the steering controller 143 can operate the beam scanner 124 so as to provide the system output signal with the directions indicated by the scan pattern.

The one or more system output signals can be scanned between different regions of interest on a workpiece without generating LIDAR data for sample regions outside of the regions of interest or generating LIDAR data for a lower density of sample regions outside of the regions of interest than is present inside of the sample regions. As a result, the system output signal can be scanned directly from one region of interest on the workpiece to another region of interest on the workpiece. In some instances, a ratio of the density of sample regions outside of the regions of interest for which LIDAR data is generated: the density of sample regions inside of the regions of interest for which LIDAR data is generated is greater than or equal to 0:1 and less than or equal to 0.1:1, 0.2:1, or 0.5:1.

As noted above, the scan of each region of the interest by the LIDAR system 344 generates LIDAR data for at least a portion of sample regions within the region of the interest 370. The LIDAR data for a sample region includes the distance between the LIDAR system and an object located in the sample region. As a result, the LIDAR data for all or a portion of the sample regions in a scan of a region of interest include the distance between the LIDAR system and the portion of the workpiece within the sample region. Since different sample regions in a field of view have different locations within the field of view, the LIDAR data for each region of interest combined with the location of each sample region within the field of view serves as a point cloud for each region of interest where all, or a portion, of the points in the cloud each indicates a location of the surface of the workpiece relative to the LIDAR system. Since the workpiece is located in the evaluation space, all, or a portion, of the points in the cloud each indicates a location of the surface of the workpiece in the evaluation space. The point cloud can serve as a workpiece point cloud. The workpiece point cloud can be expressed in spherical coordinates where each sample region is associated with a direction represented by the polar angle and the azimuthal angle of spherical coordinate systems and is also associated with the distance between the LIDAR system and the portion of the workpiece within the sample region. The workpiece point cloud can serve as a three-dimensional image of the workpiece and/or region(s) of interest of the workpiece that is compared to a reference image generated from the model. The workpiece point cloud is often in spherical coordinates but can optionally be converted to other coordinates such as the evaluation space coordinates using common coordinate transformations. Is some instances, the electronics 32 convert the workpiece point cloud from spherical coordinates to evaluation space coordinates. For instance, in some instances, the LIDAR data generator 269 converts the workpiece point cloud from spherical coordinates to evaluation space coordinates.

When the model file does not include a point cloud representation of the model, the representation of the model in the model file can be converted to a point cloud representation of the model and/or a point cloud representation of the region(s) of interest of the model. The conversion can be performed by the processor 349. Alternately, the conversion can be performed outside of the quality control system and the resulting point cloud data can be loaded into the quality control system. The point cloud representation can be stored in the one or more storage devices 348 and can be included in the model file or can be included in another file. The point cloud representation can serve as a model point cloud. The model point cloud serve as a three-dimensional image of the model and/or region(s) of interest of the model that is used as a reference image against which a region of interest on the workpiece is compared.

A model point cloud generated from the model file will often be in model space coordinates, however, the electronics 382 can optionally transform the model point cloud to the evaluation space coordinates such that the position of the model in the evaluation space is at, or is substantially at, the position of the workpiece in the evaluation space with the orientation of the workpiece in the evaluation space. For instance, the electronics 382 can use the coordinate transformation matrix to transform the model point cloud from model coordinates to the evaluation space coordinates. The model point cloud in evaluation space coordinates can also optionally be converted to spherical coordinates. For instance, the model point cloud in evaluation space coordinates can be converted to spherical coordinates when it is desirable for the model point cloud and the workpiece point cloud to have spherical coordinates. In some instances, the processor 349 and/or the workpiece evaluator 380 transforms the model point cloud from model coordinates to the evaluation space coordinates and/or converts the model point cloud in evaluation space coordinates to spherical coordinates.

The quality control electronics 381 can include a workpiece evaluator 380 that receives the data representing the workpiece point cloud and the data representing the model point cloud. For instance, the workpiece evaluator 380 can receive the workpiece point cloud from the electronics 32 and the model point cloud from the preliminary camera electronics 347. In some instances, the workpiece evaluator 380 receives the workpiece point cloud from the LIDAR data generator 269 and the model point cloud from the one or more storage devices 348. In some instances, the processor 349 performs the functions of the workpiece evaluator 380. Accordingly, in some instances, the workpiece evaluator 380 is included in the processor 349.

The workpiece evaluator 380 is configured to compare the geometry of each region of interest on the workpiece to the geometry of the corresponding region of interest on the model. For instance, the workpiece evaluator 380 can align a region of interest from the workpiece point cloud with the corresponding region of interest from the model point cloud. Suitable approaches for aligning regions of interest from the workpiece point cloud and the model point cloud include, but are not limited to, point set registration. In some instances, the workpiece evaluator 380 aligns regions of interest from the workpiece point cloud and the model point cloud using an Iterative Closest Point (ICP) algorithm. In some instances, the workpiece evaluator 380 aligns regions of interest from the workpiece point cloud and the model point cloud using a Minimum Mean Square Error (MMSE) algorithm. The workpiece evaluator 380 can then determine the degree of alignment that can be achieved between the region of interest from the workpiece point cloud and corresponding region of interest from the model point cloud. For instance, the workpiece evaluator 380 can calculate one or more alignment values that indicate degree of alignment between regions of interest. As an example, the workpiece evaluator 380 can calculate a Root Mean Square Error (RMSE) value for the aligned region of interest, and/or calculate a Mean Square Error (MSE). In some instances, the workpiece evaluator 380 calculates the Root Mean Square Error (RMSE) and/or the Mean Square Error (MSE) for the aligned region of interest.

In some instances, the geometry of each region of interest on the workpiece is compared to the geometry of the corresponding region of interest on the model with the model point cloud and the workpiece point cloud using the same coordinate system. As a result, alignment between a region of interest from the workpiece point cloud with the corresponding region of interest from the model point cloud can be done with the workpiece point cloud and the model point cloud using evaluation space coordinates. For instance, in some instances, the processor 349 and/or the workpiece evaluator 380 uses the coordinate transform matrix to transform the model point cloud from model coordinates to the evaluation space coordinates and the LIDAR data generator 269 or the workpiece evaluator 380 converts the workpiece point cloud from spherical coordinates to evaluation space coordinates. The transform of the model point cloud and the conversion of the workpiece point cloud can be done before, or included in, comparing the geometry of each region of interest on the workpiece to the geometry of the corresponding region of interest on the model point cloud. In some instances, the transform of the model point cloud and the conversion of the workpiece point cloud can be done before, or as part of, aligning each region of interest on the workpiece to the corresponding region of interest on the model point cloud.

Since the one or more alignment values indicate the degree of alignment between a point cloud that represents the surface of the workpiece and point cloud that represents the surface of the model workpiece, the one or more alignment values indicates the similarity of the shape of a region of interest on workpiece to the shape of the corresponding region of interest on the model workpiece, the similarity of the dimensions of the region of interest on the workpiece to the dimensions of the corresponding region of interest on the model workpiece, the similarity between the geometry of features such as curves in edges and surfaces, bumps, recesses, projections, openings, holes, a region of interest on workpiece with corresponding features on the corresponding region of interest on the model workpiece. Additionally, the degree of alignment also indicates the similarity in the distance(s) between features on the workpiece and the distance(s) between corresponding features on the model workpiece. As a result, the one or more alignment values indicate the degree to which a region of interest on the workpiece is a geometric match to corresponding region of interest on the model workpiece.

The workpiece evaluator 380 can apply one or more geometric matching criterion to the one or more alignment values. For instance, all, or a portion, of the one or more alignment values can each be associated with an alignment value threshold. For instance, the Root Mean Square Error (RMSE) can be associated with a Root Mean Square Error (RMSE) threshold and the Mean Square Error (MSE) can be associated with a Root Mean Square Error (RMSE) threshold. The workpiece evaluator 380 can compare one or more alignment values to the associated alignment value threshold.

The workpiece evaluator 380 can assign one or more evaluation classifications to a region of interest in response to the results of comparing the one or more alignment values to the associated alignment value threshold. As an example, the workpiece evaluator 380 can classify a region of interest as “not failed” or “failed” in response to the results of comparing the one or more alignment values to the associated alignment value threshold. In one example, the workpiece evaluator 380 classifies a region of interest as “failed” in response to the Root Mean Square Error (RMSE) for the region of interest being greater than a Root Mean Square Error (RMSE) threshold and classifies the region of interest as “not failed” in response to the Root Mean Square Error (RMSE) for the region of interest being less than or equal to the Root Mean Square Error (RMSE) threshold.

The workpiece evaluator 380 can perform the above operations so as to generate the one or more alignment values for one, all, or a portion, of the regions of interest on the workpiece. The workpiece evaluator 380 can compare one or more alignment values to the associated alignment value threshold for one, all, or a portion, of the regions of interest on the workpiece. The workpiece evaluator 380 can assign the one or more evaluation classifications to a region of interest for one, all, or a portion, of the regions of interest on the workpiece.

The workpiece evaluator 380 can assign one or more workpiece evaluation classifications to the workpiece in response to the classification of one or more regions of interest on the workpiece. For instance, the workpiece evaluator 380 can assign the workpiece a classification of “failed” in response to one, more than one, or all regions of interest on the workpiece being classified as “failed.” As another example, the workpiece evaluator 380 can assign the workpiece a classification of “passed” in response each region of interest on the workpiece being classified as “not failed.”

Because the point density in the one or more regions of interest is generally substantially higher in the model point cloud than in the workpiece point cloud reliable results can generally be achieved for the alignment of the point clouds and the evaluation of that alignment.

As shown in FIG. 8, the quality control electronics 381 can include the electronics 32, the preliminary camera electronics 347, and the workpiece evaluator 380. Although the electronics 32 are disclosed as being included in the LIDAR system, all or a portion of the electronics 32 can be included in the preliminary camera or elsewhere in the quality control system. Although the preliminary camera electronics 347 are disclosed as being included in the preliminary camera, all or a portion of the preliminary camera electronics 347 can be included in the LIDAR system or elsewhere in the quality control system. Although the workpiece evaluator 380 is shown as being external to the preliminary camera and the LIDAR system, all, or a portion of the workpiece evaluator 380 can be located within the preliminary camera and/or the LIDAR system.

Although the region(s) of interest are disclosed as being smaller than the workpiece and covering a portion of the workpiece, the workpiece can fit within the region of interest. Accordingly, the entire workpiece can serve as a region of interest. A configuration where a region of interest covers an entire workpiece is suitable for smaller workpiece sizes.

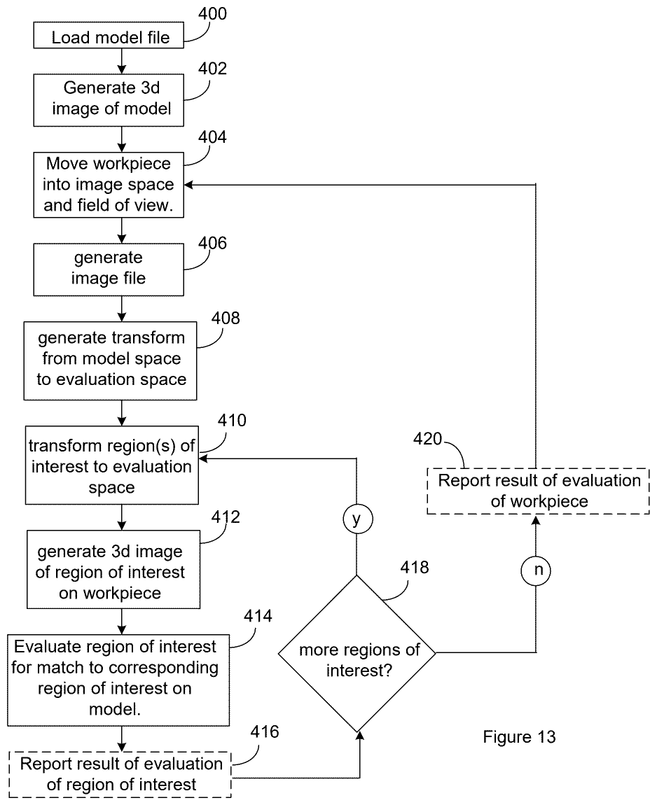

FIG. 13 is a flow diagram for one example of operation of the quality control system. At process block 400, a model file for one or more workpieces that are to be evaluated by the quality control system are loaded into the quality control system. For instance, an operator can cause a model filed to be stored in the one or more storage devices 348.

At process block 402, when the model file does not have a three-dimensional image of the model and/or region(s) of interest of the model for use as a reference image against which a region of interest on the workpiece can be compared, a three-dimensional image of the model and/or region(s) of interest of the model can be generated such that the three-dimensional image can be used as a reference image against which a region of interest on the workpiece can be compared. For instance, in instances where a point cloud representation of the model is used as a three-dimensional image of the model and the model file does not have a point cloud representation of the model, the representation of the model in the model file can be converted to a point cloud representation of the model and/or a point cloud representation of the region(s) of interest of the model. The conversion can be performed by the processor 349 or other component of the electronics.

At process block 404, the workpiece is moved into the evaluation space and the field of view. The entire workpiece can be moved into the evaluation space and the field of view or only a portion of the workpiece having the one or more regions of interest can be moved into the evaluation space and the field of view. The movement into the field of view can be performed by one or more operators or by a conveyor belt, robot, or other machinery.

At process block 406, the image file is generated. For instance, the processor 349 can operate the preliminary camera such that the image file is generated. The generation of the image file can be initiated by an operator using a user interface, by a signal from machinery that moves the workpiece into the evaluation space and the field of view, or by a signal from one or more sensors that detect the presence of the workpiece at a desired location within the evaluation space and the field of view.

At process block 408, the transform from the model space to the evaluation space is generated. For instance, the processor 349 can compare the image of the workpiece in the image file to the model in the model file so as to determine the pose of the camera relative to the model in the model space, convert the pose of the camera relative to the model in the model space to a pose of the LIDAR system relative to the model in the model space, and determine an inverse of the pose of the LIDAR system relative to the model in the model space.

At process block 410, the transform is used to transform the location of a region of interest in the model file from the model space to a location in the evaluation space. For instance, the processor 349 can apply the transform to the location of the region of interest so as to convert the location of the region of interest from model space coordinates to evaluation space coordinates.

At process block 412, a three-dimensional image of the region of interest is generated. For instance, the LIDAR system 344 can scan the system output signal within evaluation space within the location of the region of interest in the evaluation space. As an example, the steering controller 143 can operate the beam scanner 124 to steer the system output signal within the evaluation space to a series of different sample regions 144 within the location of the region of interest 370 in the evaluation space. The LIDAR system can generate LIDAR data for the sample regions such that the LIDAR data includes data for a point cloud that represents the geometry of the region of interest. The point cloud can serve as the three-dimensional image of the region of interest on the workpiece.

At process block 414, the region of interest is evaluated for the degree of match between the geometries of the workpiece and the model. For instance, the workpiece evaluator 380 can align the region of interest in the three-dimensional image of the region of interest on the workpiece and the corresponding region of interest in the three-dimensional image of the model and/or region(s) of interest. As an example, the workpiece evaluator 380 can align a point cloud for the region of interest on the workpiece with a point cloud for the corresponding region of interest on the model. The workpiece evaluator 380 can calculate one or more alignment values that indicate a degree of alignment between the region of interest in the three-dimensional image of the region of interest on the workpiece and the corresponding region of interest in the three-dimensional image of the model and/or region(s) of interest. In some instances, the workpiece evaluator 380 assigns one or more evaluation classifications to the region of interest in response to the values of the one or more alignment values.

At process block 416, the quality control system can optionally display all, or a portion, of the one or more alignment values and/or all, or a portion, of the one or more evaluation classifications to an operator of the quality control system through a user interface such as a monitor. For instance, the workpiece evaluator 380 can optionally cause all, or a portion, of the one or more alignment values and/or all, or a portion, of the one or more evaluation classifications to be displayed to an operator of the quality control system on a user interface. Additionally, or alternately, the quality control system can optionally output a signal indicating the values of all, or a portion, of the one or more alignment values and/or all, or a portion, of the one or more evaluation classifications. For instance, the workpiece evaluator 380 can optionally output a signal indicating the values of all, or a portion, of the one or more alignment values and/or all, or a portion, of the one or more evaluation classifications. The signal can be received by machinery. In some instance, the machinery receiving the signal can take further action on the workpiece in response to the signal.

At branch block 418, the quality control system can optionally assign the one or more workpiece evaluation classifications to the workpiece in response to the classification of one or more regions of interest on the workpiece and/or in response to the value of one or more of the one or more alignment values. For instance, the workpiece evaluator 380 can optionally assign the one or more workpiece evaluation classifications to the workpiece in response to the classification of one or more regions of interest on the workpiece and/or in response to the value of one or more of the one or more alignment values. At process block 418, the quality control system can optionally display one or more results selected from the group consisting of the one or more alignment values, the one or more evaluation classifications, and the one or more workpiece evaluation classifications to an operator of the quality control system through a user interface such as a monitor. For instance, the workpiece evaluator 380 can optionally cause one or more results selected from the group consisting of the one or more alignment values, the one or more evaluation classifications, and the one or more workpiece evaluation classifications to be displayed on a user interface. Additionally, or alternately, the quality control system can optionally output a signal indicating the value of one or more results selected from the group consisting of the one or more alignment values, the one or more evaluation classifications, and the one or more workpiece evaluation classifications to an operator of the quality control system through a user interface such as a monitor. For instance, the workpiece evaluator 380 can optionally output a signal indicating the value of one or more results selected from the group consisting of the one or more alignment values, the one or more evaluation classifications, and the one or more workpiece evaluation classifications to an operator of the quality control system through a user interface such as a monitor. The signal can be received by machinery. In some instance, the machinery receiving the signal can take further action on the workpiece in response to the signal.

The operations in the process flow of FIG. 13 can be performed in a sequence other than the illustrated sequence. For instance, the transform of the region of interest disclosed in the context of process block 410 can be done for multiple regions of interest before proceeding to process block 412. Accordingly, in some instances, the process can proceed from branch block 418 to process block 410. Similarly, the generation of three-dimensional images of the region of interest at process block 412 can be done for multiple regions of interest before proceeding to process block 414. Accordingly, in some instances, the process can proceed from branch block 418 to process block 414.

The coordinate transformations between the model space coordinates and the evaluation space coordinates are disclosed in the context of being performed using a coordinate transformation matrix, however, since a coordinate transformation matrix can often be constructed from a translation vector and a rotation matrix, these coordinate transformations can be performed using the translation vector and a rotation matrix.

In some instances, the workpiece evaluators 380 and/or quality control electronics 381 perform all or a portion of the functions attributed to the preliminary camera electronics 347 and/or processor 349. Functionality attributed to the processor 349 and/or one or more storge devices 348 can be considered to be performed by the preliminary camera electronics 347 and the electronics 382. Functionality attributed to the data processor 236, transformer 238, LIDAR data generator 269, transform component 268 can be considered to be performed by the electronics 32. Functionality attributed to the electronics 32 and the preliminary camera electronics 347 can be considered to be performed by the electronics 382.

The quality control electronics 381, electronics 32, preliminary camera electronics 347, processor 349, one or more storge devices 348 and/or workpiece evaluators 380 can be separate components or can be combined in different entities or a single entity. Different entities that each include one or more components selected from the quality control electronics 381, electronics 32, preliminary camera electronics 347, and/or workpiece evaluators 380 can include a controller that includes or consists of analog electrical circuits, digital electrical circuits, processors, microprocessors, digital signal processors (DSPs), Field Programmable Gate Arrays (FPGAs), Central Processing Units (CPUs), computers, microcomputers, or combinations suitable for performing the operation, monitoring and control functions described above. In some instances, the controller has access to a memory that includes instructions to be executed by the controller during performance of the operation, control and monitoring functions. Suitable memories include, but are not limited to, ROMs and RAMs.

In some instances, the functions of a LIDAR data generator and the peak finder can be executed by Field Programmable Gate Arrays (FPGAs), digital signal processors (DSPs), Application Specific Integrated Circuits, firmware, software, hardware, and combinations thereof. An example of a suitable data processor 236 executes the attributed functions using firmware, hardware, or software or a combination thereof. An example of a suitable steering controller 143 executes the attributed functions using firmware, hardware, or software or a combination thereof.

An example of a suitable processor 349 executes the attributed functions using firmware, hardware, software or a combination thereof. An example of a suitable workpiece evaluators 380 executes the attributed functions using firmware, hardware, software or a combination thereof.

The above LIDAR systems include multiple optical components such as a LIDAR chip, LIDAR adapters, light source, light sensors, waveguides, and amplifiers. In some instances, the LIDAR systems include one or more passive optical components in addition to the illustrated optical components or as an alternative to the illustrated optical components. The passive optical components can be solid-state components that exclude moving parts. Suitable passive optical components include, but are not limited to, lenses, mirrors, optical gratings, reflecting surfaces, splitters, demulitplexers, multiplexers, polarizers, polarization splitters, and polarization rotators. In some instances, the LIDAR systems include one or more active optical components in addition to the illustrated optical components or as an alternative to the illustrated optical components. Suitable active optical components include, but are not limited to, optical switches, phase tuners, attenuators, steerable mirrors, steerable lenses, tunable demulitplexers, tunable multiplexers.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A quality control system, comprising:
a camera configured to generate data for a two-dimensional image of a three-dimensional workpiece positioned in an evaluation space;
electronics that store a model file that indicates a position of a model within a model space, the model being a model of the workpiece,
the model file containing a location of a region of interest within the model space, the region of interest being a region of the model,
the electronics being configured to transform the location of the region of interest within the model space to a location of the region of interest within the evaluation space; and
a LIDAR system configured to scan a system output signal within the evaluation space such that the system output signal is scanned to multiple sample regions within the location of the region of interest in the evaluation space.

2. The system of claim 1, wherein the LIDAR system is configured to generate LIDAR data for each of the sample regions, the LIDAR data for each sample region indicating a distance between the LIDAR system and the portion of the workpiece within the sample region.

3. The system of claim 2, wherein the LIDAR system is configured to combine light from a system return signal with light from a reference signal so as to generate a composite signal beating at a beat frequency, the system return signal including light from the system return signal after the system return signal has been reflected by an object external to the LIDAR system.

4. The system of claim 1, wherein the transform is such that the location of the region of interest within the evaluation space relative to the workpiece approximates the location of the region of interest relative to the model in the model space.

5. The system of claim 1, wherein the workpiece is one of multiple different workpieces and the LIDAR system is configured to scan the system output signal within the same the region of interest on each of the workpieces when the workpieces are positioned at different locations and orientations within the evaluation space.

6. The system of claim 1, wherein the electronics are configured to generate a transform from the model space to the evaluation space.

7. The system of claim 6, wherein the transform includes a transformation matrix from the model space to the evaluation space.

8. The system of claim 6, wherein generating the transform from the model space to the evaluation space includes determining a pose of the camera relative to the model in the model space.

9. The system of claim 8, wherein determining the pose of the camera relative to the model in the model space includes performing a Perspective-n-Point (PNP) algorithm.

10. The system of claim 8, wherein generating the transform from the model space to the evaluation space includes converting the pose of the camera relative to the model in the model space to a pose of the LIDAR system relative to the model in the model space.

11. The system of claim 10, wherein generating the transform from the model space to the evaluation space includes calculating a pose of the LIDAR system relative to the model in the evaluation space.

12. The system of claim 10, wherein generating the transform from the model space to the evaluation space includes approximating a pose of the LIDAR system relative to the workpiece in the evaluation space.

13. The system of claim 10, wherein the region of interest within the evaluation space is one of one or more regions of interest within the evaluation space and the LIDAR system is configured to scan the system output signal within the evaluation space such that a ratio of a density of sample regions for which the LIDAR system calculates LIDAR data outside of the one or more regions of the interest: a density of sample regions for which the LIDAR system calculates LIDAR data inside the one or more regions of the interest is greater than or equal to 0:1 and less than or equal to 0.5:1.

14. The system of claim 1, wherein the electronics calculate an alignment value that indicates a degree of alignment that can be achieved between the region of interest on the workpiece and the region of interest on the model.

15. The system of claim 2, wherein the electronics are configured to generate a workpiece point cloud from the LIDAR data.

16. The system of claim 15, wherein the electronics are configured to compare the workpiece point cloud to a model point cloud, the model point cloud being a point cloud representation of a region of interest of the model.

17. The system of claim 16, wherein the electronics calculate an alignment value that indicates a degree of alignment between the region of interest as represented by the workpiece point cloud with the region of interest as represented by the model point cloud.

18. The system of claim 17, wherein the alignment value is selected from a group consisting of a Root Mean Square Error (RMSE) and a Mean Square Error (MSE).

19. A method of quality control, comprising:
generating data for a two-dimensional image of a three-dimensional workpiece positioned in an evaluation space;
storing a model file that indicates a position of a model within a model space, the model being a model of the workpiece,
the model file containing a location of a region of interest within the model space, the region of interest being a region of the model,
the electronics being configured to transform the location of the region of interest within the model space to a location of the region of interest within the evaluation space; and
operating a LIDAR system so as to scan a system output signal within the evaluation space such that the system output signal is scanned to multiple sample regions within the location of the region of interest in the evaluation space.
